(19) United States
(12) Patent Application Publication
(10) Pub. No.: US 2012/0229469 A1
(43) Pub. Date: Sep. 13, 2012

(54) DYNAMIC 3D ANALYTIC TOOLS: A METHOD FOR MAINTAINING SITUATIONAL AWARENESS DURING HIGH TEMPO WARFARE OR MASS CASUALTY OPERATIONS

(76) Inventor: Todd E. LIZOTTE, Hooksett, NH (US)

(21) Appl. No.: 13/290,576

(22) Filed: Nov. 7, 2011

Related U.S. Application Data
(60) Provisional application No. 61/411,185, filed on Nov. 8, 2010.

(51) Int. Cl. G06T 11/20

(52) U.S. Cl. 345/440

(57) ABSTRACT

A system and method for generating a spherical situation display representing the state of a monitored variable of a system, including a hub representing the system to be monitored, at least one variable cone representing a variable of the system with each variable cone extending radially from a hub and having a radial extent and width representative of a characteristic of a variable of the system, at least one threshold shell representing a boundary of a characteristic of a variable of the system, a trend shell representing a current value of a characteristic of a variable, and modifying a characteristic of a variable cone to represent a corresponding change of a variable of the system.

### CROSS REFERENCE TO RELATED APPLICATIONS

The present application is related to and claims benefit of U.S. Provisional Patent Application Ser. No. 61/411,185 filed Nov. 8, 2011 by Todd Lizotte for Dynamic 30 Visual Analytic Tools: A Method for Maintaining Situational Awareness during High Tempo Warfare or Mass Casualty Operations.

### FIELD OF THE INVENTION

The present invention relates to a system and method for maintaining situational awareness by displaying information representing at least one aspect of a time varying state of at least one process, system or environment wherein the display of information is characterized according to at least one relationship between at least one aspect of the state of the process, system or environment and at least one threshold condition related to the process, system or environment.

### BACKGROUND OF THE INVENTION

A necessary requirement for the monitoring, management and control of a process, system or environment is an effective process for the collection, integration, analysis and presentation of information pertaining to the process, system or environment from a multitude of data sources and formats and in time frames allowing meaningful decisions for the monitoring, management and control of the process, system or environment. The result of this process is commonly referred to as “situational awareness”, which may be defined, in brief, as possession of the information necessary to effectively monitor, management and control the process, system or environment.

Processes, systems or environments for which it is necessary and desirable to gain situational awareness may range from the relatively simple or slowly evolving to the highly complex and rapidly changing. Examples of complex, high tempo situations may include, for example, but not be limited to, the management of major, large area military operations, mass casualty events such as bioterrorism or nuclear events and natural disasters, emergency medical services, complex, real time financial systems, air traffic control and automotive traffic control in unusual or emergency situations. Apparently simpler and slower developing processes, systems and environments may include, for example, basic and routine business, administrative, educational, public service and medical service functions, long term financial processes and routine automotive and rail traffic flow control, inventory, ordering and shipping monitoring and control, restaurant operations. Such apparently lower speed and simpler systems also require effective situational awareness, however, as such systems do develop critical situations and because such systems present their own characteristic situational problems. For example, their slow developing and undramatic nature often results in the development of critical factors being overlooked until the situation evolves into a crisis and the typically slower response times of such systems requires a correspondingly longer lead time for corrective measures to be effective.

There have been a multitude of approaches, systems and processes developed to provide situational awareness in a correspondingly broad range of applications, all of which have shown themselves to be critically deficient in any of a number of respects.

For example, the capabilities and possible operation of any system or process for situational awareness is dependent upon, and is thus limited by, the concept or theory of situational awareness upon which it is based.

First considering the basic processes by which situational awareness has historically been derived from the information available, one of the most commonly implemented principles for the situational awareness process has been defined as comprised of the steps of first perceiving relevant information from the environment, system, process, self, and so on, secondly integrating and understanding that information in conjunction with, or in the context of, the goals to be achieved, and, finally, predicting future events and system states based upon that understanding of the situation. Any system or process for providing situational awareness based upon this theory is therefore constrained to deal with the available information in three separate and sequential steps, perception of the information, comprehension of the information and projection into the future.

In real life, however, perception can be both sequential and parallel, comprehension starts with the first perceptual input, not after all of the information has been acquired and processed, and prediction itself, whether correct or in error, can start before comprehension is attained due to such factors as pre-existing mental models, partial or distorted information and other sources of errors in comprehension.

At the next level of situational awareness systems and processes, many situational awareness systems and processes have been based upon the concept of situational awareness within the context of a single person operating, controlling and managing a process or complex system. This concept in turn imposes the principle that situational awareness must be attained at each individual hierarchical level of the system or process being managed. The necessary result is that each level of the system is to a greater or lesser extent isolated from the situational awareness at higher and lower levels, and that the situational information available at each level is processed and transformed into terms and forms relevant to and comprehended at that level before being transferred upwards to the next higher level.

In situational awareness systems and processes based upon situational awareness at the individual level and extrapolation to team or hierarchical levels, therefore, there will be gaps of information, comprehension and understanding between the hierarchical levels of the system or process. As a consequence, situational awareness at each successive level becomes progressively more distant from the actual situation and distortions will appear as a result, for example, of the necessary decisions regarding what level of informational detail and what form the information is to take when passed from level to level.

Yet other problems of prior art situational awareness systems arise from, for example, limitations on the level of informational detail and rate of information acquisition that can be dealt with effectively at each level. For example, when information is presented in too great a volume, or at too high a level of detail or at too high a rate, the information perception, comprehension and analysis processes and the decision making processes may become overwhelmed, resulting in erroneous decisions. In such instances the rate of change of input information may exceed the processing rate of the comprehension-integration-decision loop, so that the situational awareness system lags the rate of change of the situation with consequent loss of control of the situation.

Too little information, or too low a level of detail in the information or too low a rate of information acquisition, however, may also result in loss of situational awareness and erroneous decisions due to lack of the information necessary to comprehend and control the situation.

In addition, it must be recognized that the information available at each level of a situational awareness system will contain “noise”, that is and for example, will be subject to errors, misrepresentations, missing information, undetected redundancies, and so on, again resulting in errors in the information comprehension and analysis and decision making processes.

These problems will be compounded, in particular, in hierarchical systems based upon relatively isolated individual levels of situational awareness, such as discussed above, because of the gaps in situational awareness and knowledge between the levels of the system.

### SUMMARY OF THE INVENTION

The present invention is directed to a method and system for generating a situational awareness display for displaying at least one state of at least one variable of a system to be monitored.

The method of the present invention, and as implemented in a system of the present invention, includes the steps of generating a spherical situation display representing the state of the at least one monitored variable of the system, including at least one hub representing the system to be monitored, at least one variable cone representing at least one corresponding variable of the system to be monitored and each variable cone extending radially from a representation of the but and having a radial extent at a width representative of a characteristic of a corresponding variable of the system. The display further includes at least one threshold shell in association with at least one variable cone wherein each threshold shell represents a boundary of at least one characteristic of the corresponding variable of the system, and modifying at least one characteristic of a variable cone of the situational awareness display to represent a corresponding change of the corresponding variable of the system.

The display may further include at least one trend shell in association with at least one variable cone wherein each trend shell representing a current value of a corresponding characteristic of the corresponding variable of the system.

The step of modifying at least one characteristic of a variable cone of the situational awareness display may include at least one of modifying a displayed visual characteristic of the variable cone and generating a corresponding non-visual indication, and may include at least one of visually rotating the variable cone in the spherical situation display to an orientation toward a viewer of the situational awareness display or modifying a second displayed visual characteristic of the variable cone, including at least one of displaying an identifier of the corresponding variable of the system, modifying at least one dimension of the visual display of the variable cone, modifying a static visual characteristic of the variable cone, and imposing a dynamic alteration of a displayed visual characteristic of the variable cone.

The method of generating a situational awareness display for displaying at least one state of at least one variable of a system to be monitored may further include detecting when a monitored variable associated with a variable cone penetrates a threshold boundary associated with the monitored variable and modifying at least one characteristic of a corresponding threshold shell, including at least one of modifying a displayed visual characteristic of the threshold shell and generating a corresponding non-visual indication. The step of modifying a displayed visual characteristic of the threshold shell may further include at least one of modifying a second displayed visual characteristic of the threshold shell, including at least one of displaying an identifier of the corresponding variable of the system, modifying at least one dimension of the visual display of the threshold shell, modifying a static visual characteristic of the threshold shell, and imposing a dynamic alteration of a displayed visual characteristic of the threshold shell.

The method for generating a situational awareness display for displaying at least one state of at least one variable of a system to be monitored may further include detecting when a monitored trend associated with a monitored variable of the system approaches a threshold boundary associated with the monitored variable and modifying at least one characteristic of the corresponding trend shell, including at least one of modifying a displayed visual characteristic of the trend shell and generating a corresponding non-visual indication. The step of modifying a displayed visual characteristic of the trend shell may include at least one of modifying a second displayed visual characteristic of the trend shell or at least one of displaying an identifier of the corresponding variable of the system, modifying at least one dimension of the visual display of the trend shell, modifying a static visual characteristic of the trend shell, and imposing a dynamic alteration of a displayed visual characteristic of the trend shell.

The system to be monitored may include a plurality of sub-systems, whereupon the method executed by the situational awareness system may include generating a situational awareness display comprised of a plurality of spherical situation displays wherein each spherical situation display represents at least one state of at least one monitored variable of a corresponding sub-system and includes at least one hub representing the sub-system to be monitored and at least one variable cone representing at least one corresponding variable of the sub-system to be monitored, wherein each variable cone extending radially from a representation of the hub and having a radial extent at a width representative of a characteristic of a corresponding variable of the sub-system, and at least one threshold shell in association with at least one variable cone wherein each threshold shell representing a boundary of at least one characteristic of the corresponding variable of the sub-system, and modifying at least one characteristic of a variable cone of a situational awareness display to represent a corresponding change of a corresponding variable of the corresponding sub-system.

At least one spherical situation display may further include at least one trend shell in association with at least one variable cone wherein each trend shell represents a current value of a corresponding characteristic of the corresponding variable of the corresponding sub-system.

The step of modifying at least one characteristic of a variable cone of the situational awareness display wherein the system to be monitored includes a plurality of sub-systems may include at least one of modifying a displayed visual characteristic of the variable cone and generating a corresponding non-visual indication, and may include at least one of visually rotating the variable cone in the spherical situation display to an orientation toward a viewer of the situational awareness display and modifying a second displayed visual characteristic of the variable cone, including at least one of displaying an identifier of the corresponding variable of the corresponding sub-system, modifying at least one dimension of the visual display of the variable cone, modifying a static visual characteristic of the variable cone, and imposing a dynamic alteration of a displayed visual characteristic o the variable cone.

The method for generating a situational awareness display for displaying at least one state of at least one variable of a system to be monitored wherein the system to be monitored includes a plurality of sub-systems may further include the steps of detecting when a monitored variable associated with a variable cone penetrates a threshold boundary associated with the monitored variable, and modifying at least one characteristic of a corresponding threshold shell, including at least one of modifying a displayed visual characteristic of the threshold shell, and generating a corresponding non-visual indication, and may include at least one of modifying a second displayed visual characteristic of the threshold shell, including at least one of displaying an identifier of the corresponding variable of the corresponding sub-system, modifying at least one dimension of the visual display of the threshold shell, modifying a static visual characteristic of the threshold shell, and imposing a dynamic alteration of a displayed visual characteristic of the threshold shell.

The method for generating a situational awareness display for displaying at least one state of at least one variable of a system to be monitored wherein the system to be monitored includes a plurality of sub-systems may further include detecting when a monitored trend associated with a monitored variable of the corresponding sub-system approaches a threshold boundary associated with the monitored variable and modifying at least one characteristic of the corresponding trend shell, including at least one of modifying a displayed visual characteristic of the trend shell and generating a corresponding non-visual indication, and may include at least one of modifying a second displayed visual characteristic of the trend shell, including at least one of displaying an identifier of the corresponding variable of the corresponding sub-system, modifying at least one dimension of the visual display of the trend shell, modifying a static visual characteristic of the trend shell, and imposing a dynamic alteration of a displayed visual characteristic of the trend shell.

The method of claim 8 for generating a situational awareness display for displaying at least one state of at least one variable of a system to be monitored wherein the system to be monitored includes a plurality of sub-systems may further include generating a spherical situation display for the system, displaying the spherical situation display corresponding to the system, and at least one of displaying the spherical situation displays corresponding to the system and to at least selected ones of the sub-systems, detecting a threshold penetration by a monitored variable of a sub-system and displaying a spherical situation display corresponding to the sub-system in which the monitored variable penetrated the threshold, and displaying the spherical situation display of a sub-system selected by a user of the situational awareness system.

The method for generating a situational awareness display for displaying at least one state of at least one variable of a system to be monitored may further include displaying information pertaining to at least one variable not represented by a variable cone, including generating and displaying one of a secondary spherical situation display for the at least one variable not represented by a variable cone of the spherical situation display, and displaying the information pertaining to the at least one variable not represented by a variable cone by generating a display of original data extracted from a data source providing data represented by the at least one variable not represented by a variable cone of the spherical situation display.

A situational awareness system for displaying at least one state of at least one variable of a system to be monitored may include an information extraction processor for extracting information pertaining to the at least one monitored variable from original information sources and generating at least one corresponding variable values representing the at least one monitored variable, a variable cone processor responsive to the at least one monitored variable for generating at least one corresponding variable cone wherein each variable cone represents at least one corresponding variable value, a threshold processor for comparing the variable values of the at least one monitored variable with at least one corresponding threshold boundary and generating a threshold boundary penetration indication when an at least one monitored variable penetrates an at least one corresponding threshold boundary, and a display generator responsive to each of the at least one variable cone and to each of the at least one threshold boundary for generating a spherical situation display. The spherical situation display may include at least one visual representation of a hub representing the system to be monitored, at least one variable cone representing the at least one corresponding monitored variable of the system wherein each variable cone extending radially from a representation of the but and having a radial extent at a width representative of a characteristic of a corresponding variable of the system, and at least one threshold shell in association with at least one variable cone wherein each threshold shell representing a boundary of at least one characteristic of the corresponding variable of the system, wherein the display generator is responsive to each variable cone and to each threshold shell for modifying at least one characteristic of a corresponding variable cone of the situational awareness display to represent the corresponding change of the corresponding monitored variable.

The situational awareness system of claim 18 for displaying at least one state of at least one variable of a system to be monitored may further include a trend processor responsive to the at least one monitored variable for generating at least one corresponding trend shell associated with a corresponding variable cone and representing changes in the at least one monitored variable wherein the display processor is responsive to the trend processor for generating a display of each at least one trend shell.

### BRIEF DESCRIPTION OF THE DRAWINGS

The invention will now be described, by way of example, with reference to the accompanying drawings in which:

FIG. 1A is a diagrammatic representation of a situational awareness system;

FIG. 1B is a diagrammatic representation of data and information relationships in a situational awareness system;

FIGS. 2A, 2B, 2C and 2D are diagrammatic representations of elements of a situational awareness system;

FIGS. 3A, 3B and 3C are diagrammatic representations of the combination of the situational awareness system elements of FIGS. 1A, 1B and 2A-2D;

FIG. 4 is a block diagram of a situational awareness system;

FIGS. 5A and 5B are diagrammatic representations of access to lower level, detail information in a situational awareness system; and

FIGS. 6A-6E are diagrammatic representations of exemplary embodiments of situational awareness systems.

### DETAILED DESCRIPTION OF THE INVENTION

### A. Introduction

As described briefly herein above, the situational awareness system and method of the present invention relates to a system and method for providing situational awareness by displaying information representing at least one aspect of a time varying state of at least one system wherein the display of information is characterized according to at least one relationship between at least one aspect of the state of the process, system or environment and at least one threshold condition related to the process, system or environment.

As will be described in the following, the situational awareness system and method of the present invention provides visibility of and access to the situational awareness process, that is, the processes of acquiring information, the acquired information, the comprehension and analysis of the acquired information and the projection thereof into the future, to all users and at all levels of the system and method. In addition, the processes comprising the situational awareness system and method of the present invention are executed continuously and both sequentially and in parallel, so that the processes of information acquisition, perception, comprehension, analysis and projection are visible and displayed to the user as various aspects of the situational awareness process and the situation itself evolve over time.

As will also be described in detail in the following, the system and method of the present invention provides a situational awareness tool for the three dimensional representation of the state of a system, process, environment, task or operation, that can track and display trends or changes in the system, process, environment, task or operation, that can indicate when parameters or values representing the state of the system, process, environment, task or operation cross determined threshold boundaries, and that provides rapid and easy access to higher resolution information pertaining to the system, process, environment, task or operation. In addition, the situational awareness system and method of the present invention is readily portable between, and adaptable to, a range of processing the display platforms and systems, ranging from computer systems and networks to portable computers, such as laptops, personal digital assistants, tablet computers and “intelligent” phones.

In brief, the situational awareness system and method of the present invention accordingly provides a dynamic visual aid to provide situational awareness for a system, process, environment, task or operation with a range of visual indicators of trends and required or desirable interventions with access to selectable levels of informational detail, including original raw data, that is, data from the original source of the data.

### B. DEFINITION OF TERMS

For purposes of the following detailed descriptions of the present invention, the term “system” shall be taken to include the terms system, process, environment, procedure, situation, task, operation, and so forth, which is to be monitored. Systems in turn are to be understood as including any form of system to be monitored and includes, for example, technology based systems, such as computer based systems and networks, industrial processes, and so on, primarily human based systems, such as police, military and medical organizations, nature based systems, such as environments, flora, fauna, geological forms and processes and natural resources, and combinations of such systems.

The term “information” as used herein refers to all forms of knowledge or information pertaining to a system, process, environment, task or operation upon which the situational awareness system and method of the present invention is employed. The term “information” as used herein includes all forms in which such knowledge is or can be expressed and includes, for example, a value, characteristic, property or descriptive expression associated with an element or variable of the system, process, environment, task or operation. Information as used herein may also include, for example, such concepts as a state of constraint, communication, or control, data, form, meaning, mental state or perception, interpretation, belief, pattern, perception, and representation. The term “data” is in turn defined as information expressed in terms of absolute or relative quantitative or qualitative values, such as a number or a descriptive or definitive term, such as “blue”, “hot”, “cooler”, and so on.

An “information source”, which is referred to in the following descriptions of the information as a “hub”, is a system, process, environment, task or operation to be monitored by the situational awareness system and method of the present invention. The “state” of an information source, or hub, is in turn comprised of the totality of information, or at least certain critical elements thereof, describing or defining at least the current status or condition of the information source and may include, at least inherently or implicitly, all information defining or describing at least one past and/or one future state of the information source.

A “threshold”, which is also referred to in the following descriptions of the situational awareness system and method of the present invention as a “threshold shell”, is a fixed or variable but defined value, condition, status or state or range of values, conditions, statuses or states with which an aspect of the information source, that is, a value, condition, status or state of the information source, is compared for the purpose of detecting when the corresponding aspect of the information source is in a defined relationship with the threshold condition. For example, is a value of the current state of the information source within a specified range of values, or has the value of the current state of the information source crossed a boundary defined by the threshold value, and so on.

Lastly, a “trend” is a rate and direction of change of the value, magnitude or other representation of a variable over time.

### C. DESCRIPTION OF A SITUATIONAL AWARENESS SYSTEM AND METHOD

### (1) Elements of a Situational Awareness System

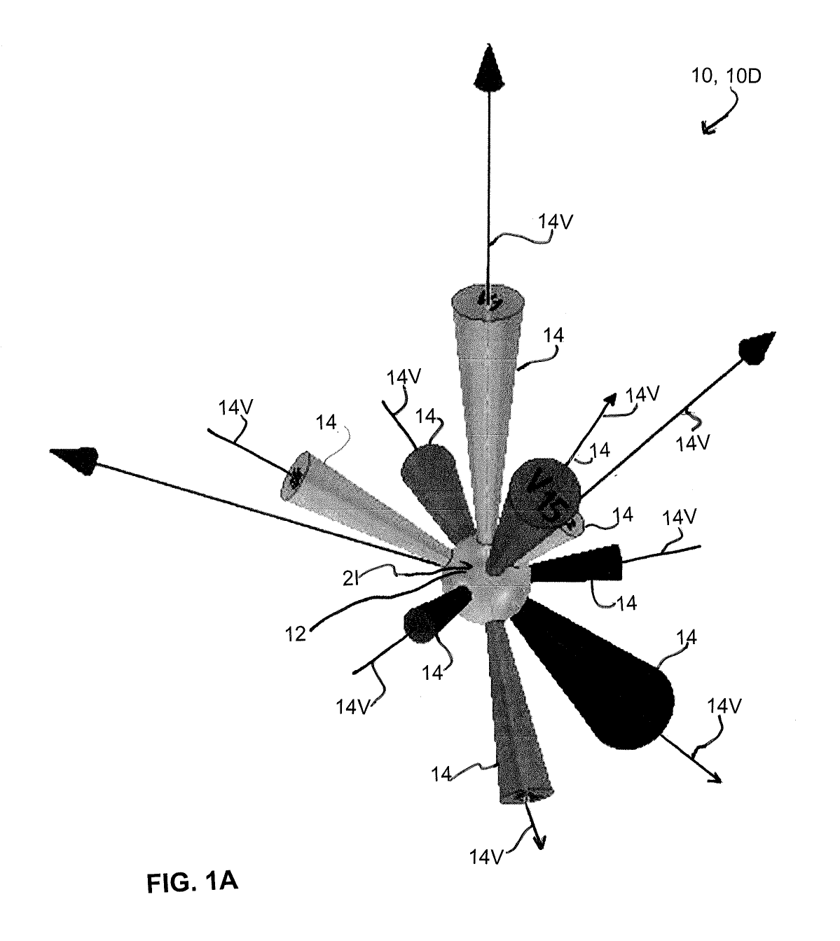

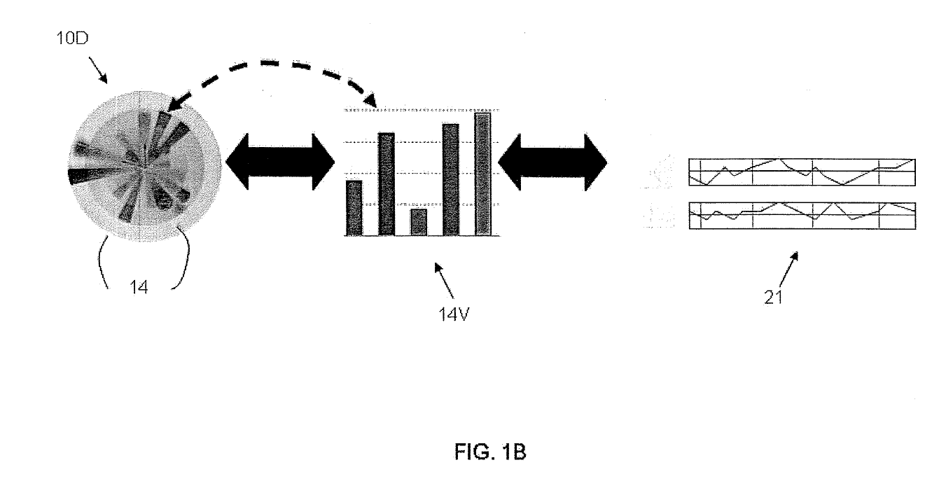

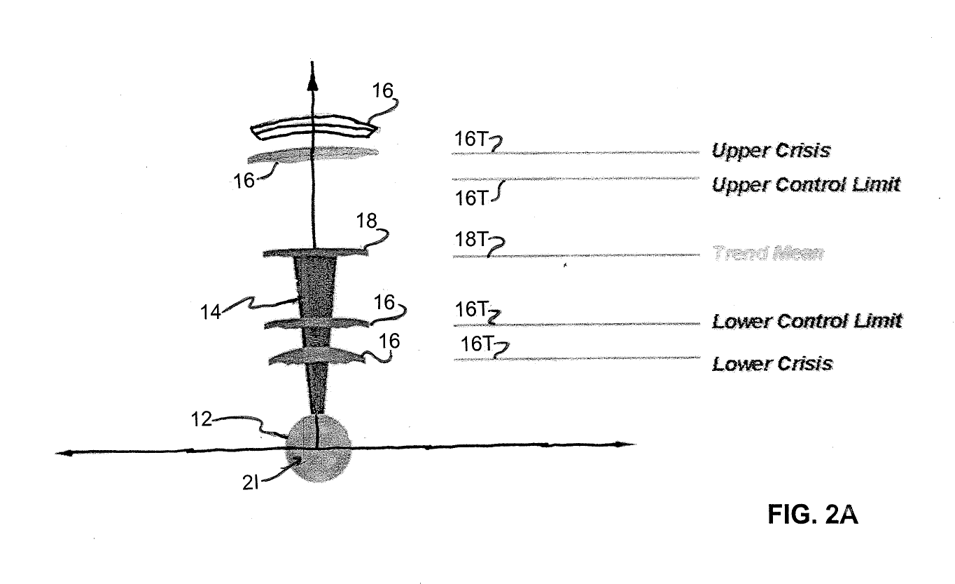

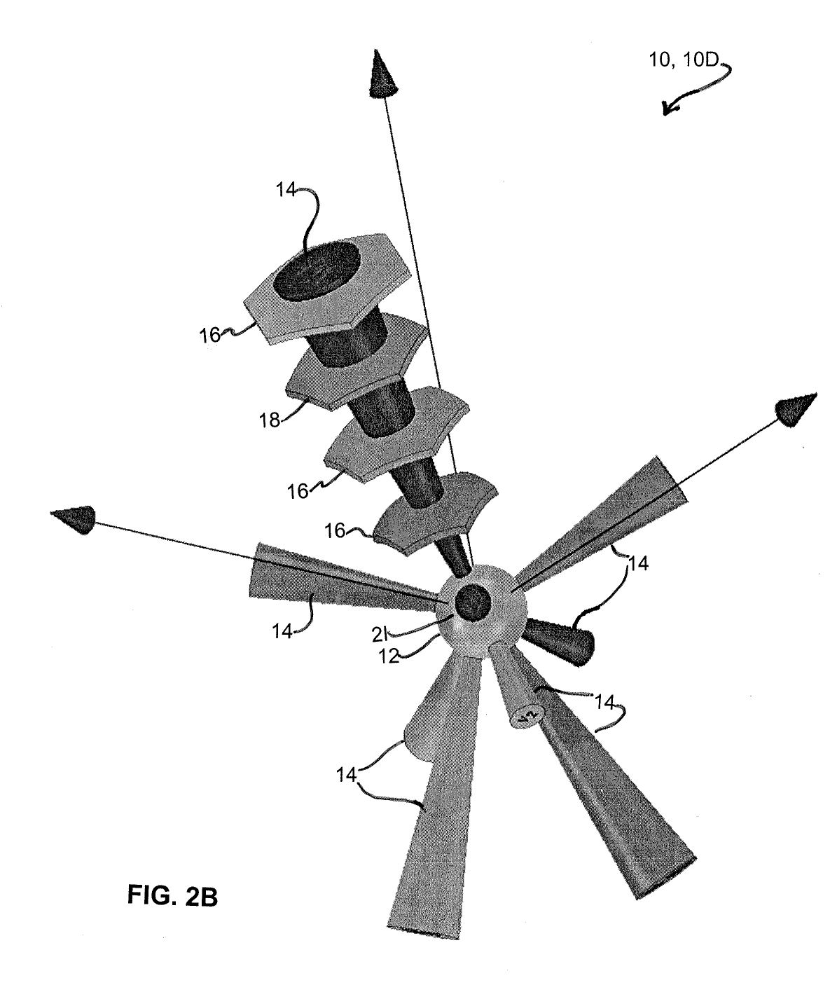

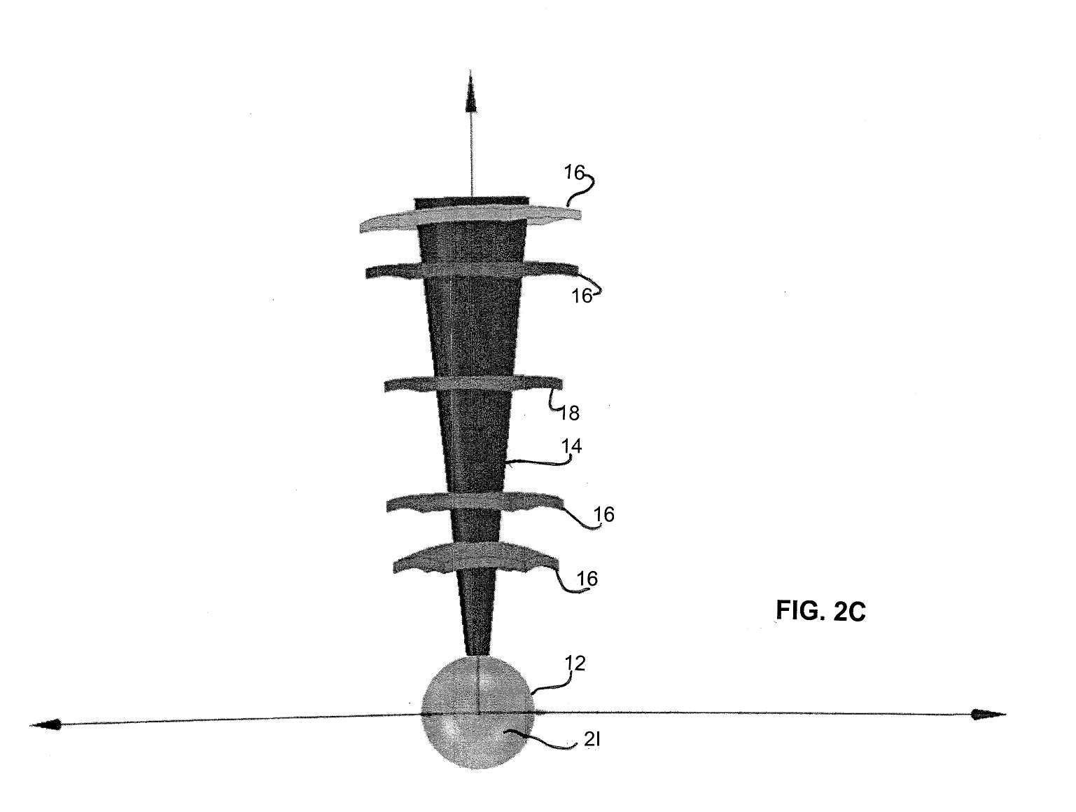

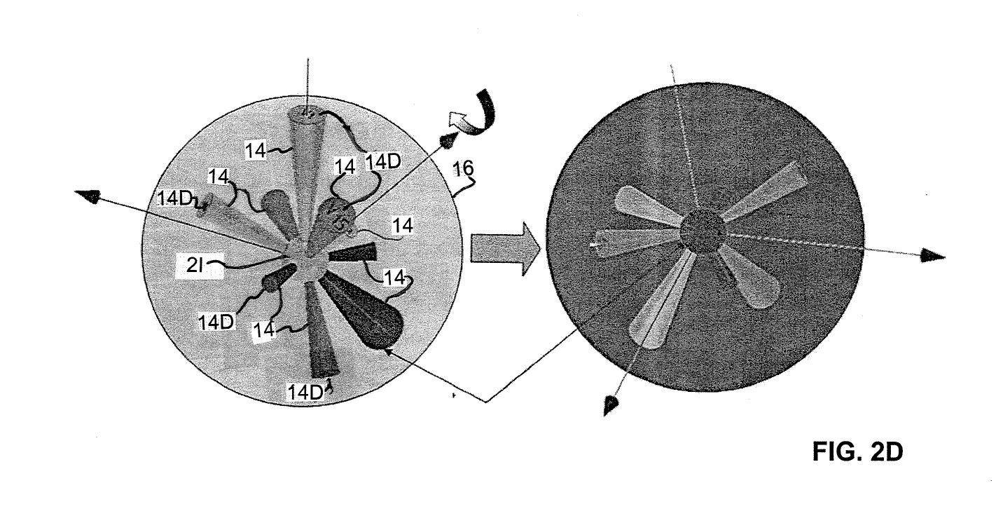

Referring to FIGS. 1A, 1B, 2A, 2B, 2C and 2D, therein are shown diagrammatic representations of the basic elements of a situational awareness system 10 and method of the present invention as displayed in a spherical situation display 10D generated by a situational awareness system 10.

As shown in FIG. 1A, an information hub 12 is system, process, environment, task or operation to be monitored by the situational awareness system 10 and includes at least one variable cone 14 representing and corresponding to at least one variable 14V of a group of variables 14V comprising one or more elements of information 2I, including data, indicative of a value, condition, status or state or range or combination of values, conditions, statuses or states of the information hub 12 that are being monitored by the situational awareness system 10.

Referring to FIG. 1B, therein is shown a diagrammatic illustration of the relationships between the original input or raw information 2I extracted or received from a system 2 to be monitored, the variables 14V representing that original information 2I, and a spherical situation display 10D generated from those variables 14V, including, as described in the following, variable cones 14 representing variables 14, threshold shells 16 representing threshold variables 16T, that is, threshold boundaries, and trend shells 18 representing trend variables 18V indicating the status and changes over time of variables 14V.

As shown therein, the type and form of original or raw information extracted or received from a system 2 to be monitored and comprising the information 2I relevant to the system 2 will be dependent, at least in part, on the type and nature of the system 2 to be monitored, the forms and types of information 2I that is present in the system 2, or is available for purposes of monitoring a system 2, and the means by which the necessary information 2I may be acquired, all of which may depend upon the specific system for which is situational awareness system 10 is to be implemented. For example, the information 2I relevant to the identified variables 14V may be acquired through appropriate instrumentation or sensors, either already present or to be installed in association with the implementation of the situational awareness system 10, or may already be available in one form or another, such as through existing networks and systems or, for example, in existing data structures or repositories, such as databases, or existing data flows. In a like manner, and may include, for example, the output of sensors or monitors, including sensing and monitoring systems, databases, processed data of all forms, including, for example, spreadsheets, texts and documents, images, data recordings or direct data inputs across a wide spectrum of signal and data sources, such as sound, including speech and speech recognition inputs, radio and microwave emissions, and so on, and including human inputs, such as impressions, responses and opinions to or regarding events and conditions.

As indicated in FIG. 1B, information 2I, which is representative of the actual condition and state of the system 2, is transformed or converted by the situational awareness system 10 into variables 14V, which represent the condition and state of the system 2 and may thereby be regarded as one level of abstraction removed from the original information 2I. It must be recognized, however, that the degree and type of transformation between information 2I and one or more corresponding variables 14V will depend upon the system 2, the aspects of the system 2 to be monitored, the type and form of the original system 2 and the type and form of the variables 14V selected or desired to represent the state and condition of the system 2. In must also be recognized that, for the same reasons, one or more elements of information 2I may be incorporated into a single variable 14V, or that a single element of information 2I may generate or be involved in a plurality of variables 14V. It must be further recognized that while a situational awareness system 10 may perform some or all of the functions, operations and processes necessary to transform or convert information 1I into the corresponding variables 14V, at least some and perhaps all of the necessary transformations and conversions may be performed by other systems or sub-systems, including elements of the system 2.

Lastly, and as illustrated in FIG. 1B, the variables 14V are transformed into corresponding variable cones 14 for display in the spherical situation display 10D of the situational awareness system 10. Again, and as in the case of the transformations and conversions between information 2I and variables 14V, the transformations and conversions between variables 14V and variable cones 14 represent a further level of abstraction of the information. As will be discussed in further detail in the following regarding systems 2 comprised of hierarchical sub-systems, thereby may be further levels of abstraction wherein the variable cones 14 of one level, that is, the elements comprising the variable cones 14 of one level, are effectively the variables 14V of the next higher level, and so on. In addition, it must be recognized that the degree and type of transformation between variables 14V and one or more corresponding variable cones 14 will depend upon the system 2, the aspects of the system 2 to be monitored, the type and form of the original system 2 and the type and form of the variables 14V selected or desired to represent the state and condition of the system 2. In addition, and again, one or more variables 14V may be incorporated into a single variable cone 14 or a single variable 14V may be involved in a plurality of variable cones 14.

Finally, and as will be discussed in detail in following descriptions of a situational awareness system 10, a situational awareness system 10 of the present invention will provide a user with the capability to “drill down” through the levels of information extraction from the top level represented by a spherical situation display 10D and, for example, the variable cones 14 and other aspects of a system 2 represented therein, to the variables 14V and even the elements 21 from which the spherical situation display 10D as derived and constructed.

Referring again to FIG. 1A, and as illustrated therein, each variable cone 14 is displayed as extending and expanding radially outwards from the hub 10 of which it is an element, with the radial length of the variable cone 14 and the width of the variable cone 14 at any radius along its lengths representing a property, characteristic or value of the corresponding variable 14V.

For example, the radial length of a variable cone 14 may represent magnitude or value of a value, characteristic or property of the variable 14V, either in itself or in relationship to a magnitude or value of a value, characteristic or property of another variable 14V or a threshold condition or value. The width of a variable cone 14 at a given radius from the hub 12 may, in turn and for example, the relative significance of that variable 14V relative to, for example, other variables 14V or with respect to the operation, state of functioning of the hub 12. As will be described further below, dynamic variations in the radial length, width and other characteristics of a variable cone 14 represent changes in the variable of variables 14V represented by the variable cone 14, such as changes in the relative or absolute significance or criticality of that variable 14V with respect to the operation, state of functioning of the hub 12, or changes and trends in the characteristics, properties or significance or criticality of the corresponding variable 14V or group of variables 14V.

Referring to FIGS. 2A, 2B, 2C and 2D, a threshold 16T is a fixed or variable value, condition, status or state or range of values, conditions, statuses or states representing a boundary or range of values, and a visual display thereof, with which the value, condition, status or state of a variable 14V represented by a variable cone 14 is compared for the purpose of determining and displaying a relationship between the corresponding variable or variables 14V of the hub 12 and the boundary or range represented by the threshold 16T.

A threshold shell 16, in turn, is a visual display of a boundary or range defined by a threshold or thresholds 16T and the visual display of a variable cone 14 and a threshold shell 16 show to the user whether the variable or variables 14V represented by the variable cone 14 is greater than or less than the boundary represented by the threshold shell 16 or falls within a range represented by one or more threshold shells 16. Each threshold shell 16 can thereby be considered as defining and implementing either or both of upper and lower limits, with or without mid-range limits, for one or more variables 14V.

A threshold 16T and a corresponding threshold shell 16 may pertain to a one or more variables 14V and corresponding variable cone 14 or to one or more variables 14V of a plurality of variable cones 14 and may be visually shown, as illustrated in FIGS. 2A-2D, as a partial shell visually associated with and intersecting with a single variable cone 14 or a group of related variable cones 14 or may be associated with an entire system 2 and may thus be visually represented as a complete spherical shell encompassing the entire hub 12 at some radius therefrom and thus intersecting with all variable cones 14 of the spherical situation display 10D.

As also illustrated in FIG. 2A, a situational awareness system 10 and spherical situation display 10D may also implement trend variables 18T and corresponding trend shells 18 wherein a trend variable 18T is a value representing, for example, the current value, magnitude, state, characteristic or other property of a variable 14V represented by variable cone 14 and the current trend of change in that value, magnitude, state, characteristic or other property of a variable 14V. A corresponding trend shell 18 is a visual representation of that trend variables 18T and is visually associated with the variable cone 14 of the variable 14V in the spherical visual display 10D generated by the situational awareness system 10. It will be noted that trend variables 18T and trend shells 18, unlike threshold variables 16T and threshold shells 16, which are typically calculated based upon expected ranges of variable 14V values, trend variables 18T and the trend shells 18 representing trend variables 18T are calculated from corresponding variable 14V values.

As illustrated in FIG. 2B, therefore, the combination of variable cones 14 and threshold shells 16 can incorporate spatial and temporal data, as well as all other forms of information, and comprises the visual representation of rules applied between the variables 14V and thresholds 16T to detect and indicate changes in the displayed relationships between variables 14V and thresholds 16T. Variable cones 14 and threshold shells 16 thereby indicate trends, including spatial and temporal trends, and represent and illustrate the application of rules embodied in the situational awareness system 10 and the triggering of spherical situation display 10D elements indicating, for example, a need for an intervention in the system, process, environment, task or operation monitored by the situational awareness system 10 situational awareness system 10.

In summary, a situational awareness system 10 can thereby monitor a selected relationship or relationships between a variable or variables 14V and one or more thresholds 16T, display that relationship or relationships in the spherical situation display 10D by means of variable cone or cones 14 and a threshold shell or shells 16, detect when that relationship or relationships fall outside an acceptable value or range according to rules incorporated into the situational awareness system 10, and can indicate that occurrence by visual changes in either or both of the variable cone 14 and threshold shell 16.

For example, as illustrated in FIG. 2D, and referring to FIGS. 2A and 2C, when a threshold shell 16 is touched or penetrated by a variable cone 14, that is, when a value, magnitude of other representation of a variable 14V represented by the variable cone 14 crosses a boundary defined by the threshold shell 16, the variable cone 14 representing that variable 14V may, for example, be visually rotated in the spherical situation display 10D so that the variable cone 14 extends radially outwards toward the viewer. A designator 14D of the variable 14V, which may be displayed on the “end” of the variable cone 14 or in some manner indicating a relationship with the variable cone 14, is then clearly visible to identify to the user the variable 14V that has crossed the threshold 16T boundary. The variable cone 14 may also change color, or begin flashing, and an audible alert may be sounded.

In yet other implementations of a situational awareness system 10 of the present invention the changes in the visual representation of the variable cone 14 in question may relate to and indicate certain aspects of the event or condition that resulted in the penetration of a threshold 16T boundary by a variable 14V represented by the effected variable cone 14. For example, the color of the variable cone 14 may indicate the criticality of the threshold penetration, such as a color shift to a spectrum ranging from yellow to flashing red representing a corresponding critical range extending from cautionary to highly critical. In other instance, a color change may represent the fundamental nature of the problem or condition that is being reported. For example, in a system for managing national emergency conditions, each variable cone 14 may correspond to a city or geographic region and the color imposed on a variable cone 14 may indicate whether a nuclear, biological, chemical or natural emergency has been detected in the corresponding city or region.

In other possible implementations of a situational awareness system 10, the visual representation of the threshold shell 16 which has been penetrated by the variable cone 14 may likewise be altered in a manner similar to those of variable cones 14, such as by a change of color or by flashing, and a threshold designator 16D associated with the threshold shell 16 may be displayed to identify the threshold 16T that has been crossed.

As in the case of threshold shells 16, a situational awareness system 10 of the present invention may monitor the values or characteristics of at least certain selected monitored variables to detect trends in the value, magnitude or other representation of a monitored variable 14V of the system, and may indicate the current state and trend of a given variable 14V or variables 14V by means of a partial or complete trend shell 18 associated with the corresponding variable cone or cones 14 of the system 2 as a whole, similar to threshold shells 16 as described above. The situational awareness system 10 may indicate such trends in the value, magnitude or other representation of a monitored variable 14V by, for example, at least one characteristic of the corresponding trend shell 18, such as the static or dynamically changing color of the trend shell 18 and the radial position of the trend shell 18 along one or more variable cones 14. A situational awareness system 10 may also indicate, by appropriate visual and/or audible indications, when a trend is approaching or has penetrated a trend boundary by modifying a displayed visual characteristic of the trend shell 18 and/or generating a corresponding non-visual indication, in a manner similar to the approach to or penetration of a threshold 16T by a variable 14V.

### (2) A Situational Awareness System

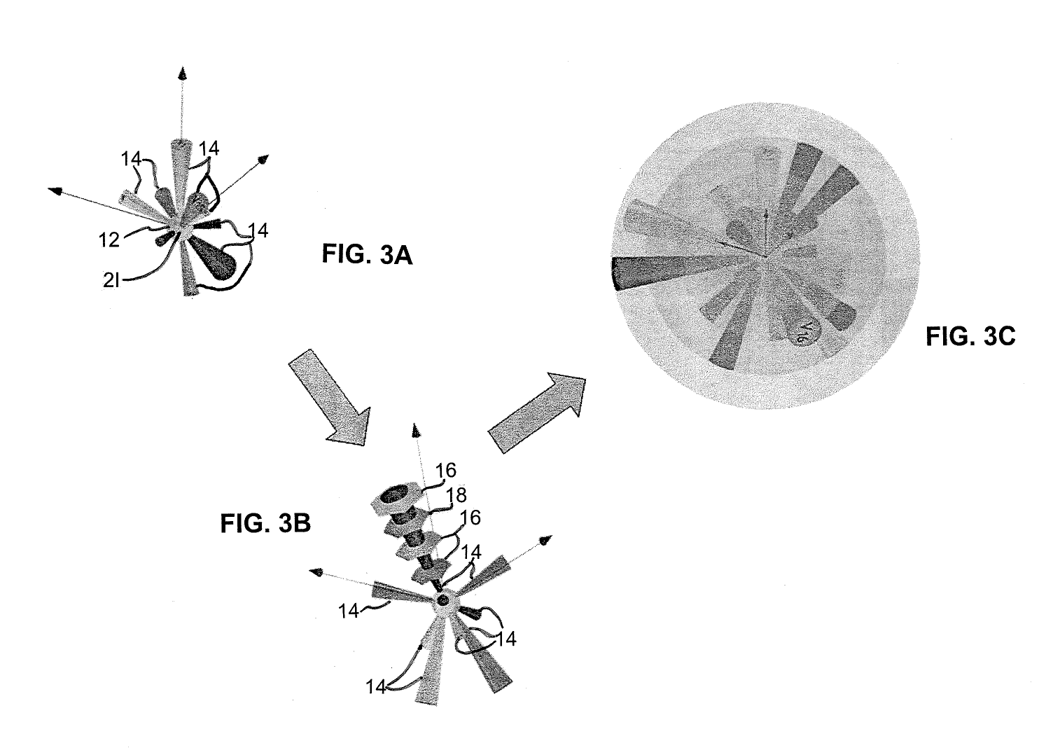

Referring to FIGS. 3A, 3B and 3C therein are shown diagrammatic representations of the combination of the situational awareness system 10 elements shown in FIGS. 1 and 2A-2D into an exemplary embodiment of a situational awareness system 10 and an exemplary spherical situation display 10D generated by the situational awareness system 10 and the general steps in constructing a situational awareness system 10 and spherical situation display 10D.

As illustrated in FIG. 3A, the construction of a situational awareness system 10 and spherical situation display 10D begins with identification of the variables 14V in or comprised of elements of information 2I that are required, or of interest, in monitoring, management and control of a system and the incorporation of the means necessary to acquire the information representation of the identified variables 14V pertinent to the system of interest. As described, the means by which the necessary information 2I may be acquired will depend upon the specific system for which is situational awareness system 10 is to be implemented, and the forms in which such information exists or may exist. For example, the information 21 relevant to the identified variables 14V may be acquired through appropriate instrumentation or sensors, either already present or to be installed in association with the implementation of the situational awareness system 10, or may already be available in one form or another, such as through existing networks and systems or, for example, in existing data structures or repositories, such as databases, or existing data flows. In a like manner, the form and nature of each element of information 2I acquired for use by a situational awareness system 2 will depend upon, for example, the type and nature of the system 2 to be monitored, the forms and types of information 2I that is present in the system 2, or is available for purposes of monitoring a system 2, and may include, for example, the output of sensors or monitors, including sensing and monitoring systems, databases, processed data of all forms, including, for example, spreadsheets, texts and documents, images, data recordings or direct data inputs across a wide spectrum of signal and data sources, such as sound, including speech and speech recognition inputs, radio and microwave emissions, and so on, and including human inputs, such as impressions, responses and opinions to or regarding events and conditions.

As discussed herein above, the identified variables 14V together comprise a hub 10 of the situational awareness system 10 and a variable cone 14 is designated and generated for each selected variable 14V and is displayed by the spherical situation display 10D. It will be understood that the creation of a variable cone 14 for a specific variable 14V will include a determination and selection of the factors that will effect the displayed characteristics of the variable cone 14, such as the radial length, width and, for example, color or other visual aspects, of the variable cone 14, and the incorporation of these factors into the functions generating the visual display of each variable cone 14.

As described herein above, and for example, the radial length of a variable cone 14 may represent magnitude or value of a value, characteristic or property of the variable 14V, either in itself or in relationship to a magnitude or value of a value, characteristic or property of another variable 14V or a threshold condition or value and the width of a variable cone 14 at a given radius from the hub 12 may, in turn and for example, the relative significance of that variable 14V relative to, for example, other variables 14V or with respect to the operation, state of functioning of the hub 12. Dynamic variations in the radial length, width and other characteristics of a variable cone 14 therefore represent changes in the variable of variables 14V represented by the variable cone 14, such as changes in the relative or absolute significance or criticality of that variable 14V with respect to the operation, state of functioning of the hub 12, or changes and trends in the characteristics, properties or significance or criticality of the corresponding variable 14V or group of variables 14V.

As illustrated in FIG. 3B, the selection and implementation of the variables 14V and variable cones 14 for a given hub 12 will be followed or accompanied concurrently by the determination and selection of the thresholds 16T, threshold shells 16, trend variables 18T and trend shells 18 that may be associated with each of the variables 14V and variable cones 14, including the values, magnitudes, characteristics, properties or other factors that determine the relationship between each threshold 16T or trend variable 18T and an associated variable 14V and variable cone 14.

Lastly, and as illustrated in FIG. 3C, the elements just described, that is, the variables 14V, variable cones 14, thresholds 16T, threshold shells 16, trend variables 18T and trend shells 18 are used by the situational awareness system 10 to generate a spherical situation display 10D.

### (3) Mechanism and Construction of a Situational Awareness System

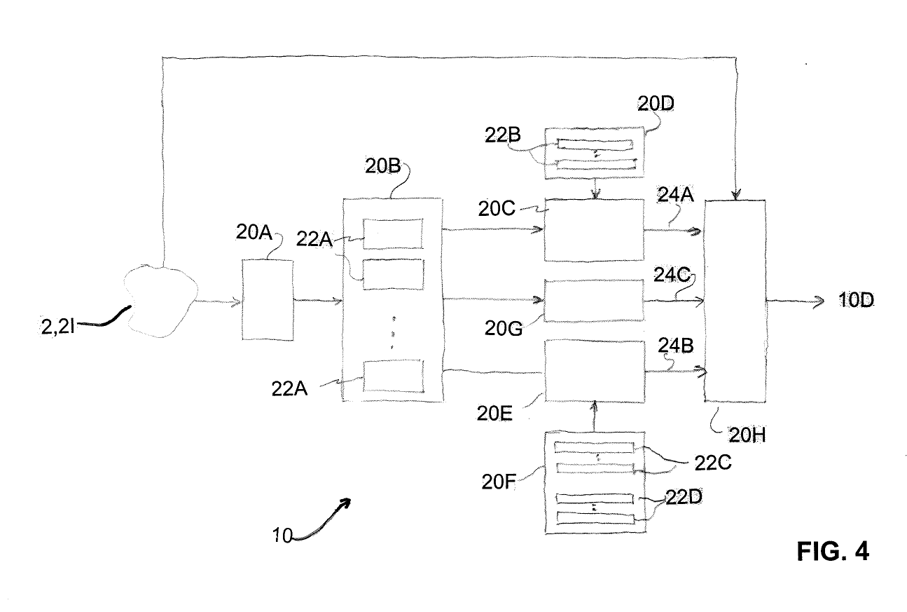

Referring to FIG. 4, therein is shown a block diagram of an exemplary embodiment of a situational awareness system 10 for generating a situational situation display 10D including a single hub 12 with a plurality of variable cones 14 with corresponding threshold shells 16 and trend shells 18. It will be readily understood by those of ordinary skill in the relevant arts, after perusal of the present disclosure of the invention, that a system 10 as illustrated in FIG. 4 may be readily expanded to display a system 2 having a plurality of hubs 12 with corresponding variable cone 14, threshold shells 16 and trend shells 18 by multiplying in the situational awareness system 10 those elements of a situational awareness system 10 as shown in FIG. 4 that are individual and specific to a given hub 12.

As illustrated therein, a situational awareness system 10 is provided with access to a system 2 to be monitored and the information 2I available therefrom and includes an information extraction processor 20A that extracts from the information 2I that information and data pertaining to be variable 14V to be monitored and displayed by the situational awareness system 10 and processes the extracted information 2I to generate the values of the corresponding variables 14V, which are stored in a variable memory 20B as variable values 22A. and are updated according to the rate of change of the information 2I and the monitoring requirements of the system 2 being monitored. It will be appreciated that the methods by which the information 2I for each variable 14V is extracted and processed will vary depending on the type, form and source of the information 2I comprising the variable 14V, the rate of change of the information 2I, the rate at which variable values 22A are to be updated, and so on.

The situational awareness system 10 further includes a variable cone processor 20C which reads variables 14V from variable memory 20B and processes the values or representations of variables 14V under control of cone definition parameters 22B stored in a cone definition memory 20D to generate cone definitions 24A defining the visual appearance that the corresponding variable cones 14 are to assume in the situational awareness display 10D. Cone definitions 24A define and describe, for example, the radial extent and width of at any radius along the possible radial extent of the variable cone 14, each of which, as described, may depend upon and represent a property, characteristic or value of the corresponding variable 14V.

For example, and as described previously, the radial length of a variable cone 14 may represent magnitude or value of a value, characteristic or property of the variable 14V, either in itself or in relationship to a magnitude or value of a value, characteristic or property of another variable 14V or a threshold condition or value. The width of a variable cone 14 at a given radius from the hub 12 may, in turn and for example, the relative significance of that variable 14V relative to, for example, other variables 14V or with respect to the operation, state of functioning of the hub 12. Dynamic variations in the radial length, width and other characteristics of a variable cone 14 may in turn represent changes in the variable of variables 14V represented by the variable cone 14, such as changes in the relative or absolute significance or criticality of that variable 14V with respect to the operation, state of functioning of the hub 12, or changes and trends in the characteristics, properties or significance or criticality of the corresponding variable 14V or group of variables 14V.

It should be noted that variable cone processor 20C and cone definitions 24A may also include the functions for the generation and display of the hub 12 defined for the monitored variables 14V of the system 2 that are to be displayed by the situational awareness display 10D.

The situational awareness system 10 further includes a threshold processor 20F that reads threshold boundary values 22C and threshold display definitions 22D stored in a threshold memory 20F and generates threshold shell definitions 24B defining the visual appearance that the corresponding threshold shells 16 are to assume in the situational awareness display 10D. For example, threshold processor 20F reads variable values 22A from variable memory 20B and compares the values or representations of variables 14V with any corresponding threshold 16T boundary values 22C to determine whether any variable 14V has penetrated a threshold 16T boundary. If a variable 14V value or representation has penetrated a relevant threshold 16T boundary, threshold processor 20E modifies the corresponding threshold shell definition 24B correspondingly, according to threshold display definitions 22D to indicate that fact. In this regard, threshold shell definitions 24B may include activation commands for, for example, audible alerts as well as visual alerts of a threshold boundary penetration.

The situational awareness system 10 further includes a trend processor 20G that, like threshold processor 20F, reads variable values 22A from variable memory 20B to calculate the trend variables 18T for those variables 14V for which trends are to be determined and generates corresponding trend shell definitions 24C defining the visual appearance assumed by corresponding trend shells 18 displayed in the situational awareness display 10D.

Lastly, the situational awareness system 10 includes a situational awareness display generator 20H that is responsive to cone definitions 24A, threshold shell definitions 24B and trend shell definitions 24C to generate the corresponding hub 12, variable cones 14, threshold shells 16 and trend shells 18 of the situational awareness display 10D, using graphical display generation techniques and methods well known to those of ordinary skill in the relevant arts.

It must be noted that, as described below, the situational awareness system 10 and situational awareness display generator 20H may include further functions, such as the capability of displaying raw data inputs, that is, original data, from information 2I or data from databases at the command of a user, or of generating and displaying multiple hubs 12 with corresponding variable cone 14, threshold shells 16 and trend shells 18 by, for example, multiplying in the situational awareness system 10 those elements of a situational awareness system 10 as shown in FIG. 4 that are individual and specific to a given hub 12.

### (4) Further Aspects and Embodiments

It will be apparent from the above descriptions of a situational awareness system 10 and spherical situation display 10D of the present invention that certain variations and alternate embodiments of a situational awareness system 10 and spherical situation display 10D may be readily implemented.

For example, it may be desirable to visually simplify the spherical situation display 10D due, for example, to the number and complexity of variable cones 14, threshold shells 16 and trend shells 18 to be displayed or limitations in the viewing or display capabilities of a device, such as a pad computer, intelligent phone or personal digital assistant, on which the spherical situation display 10D is being displayed. In such instances, and for example, it may be desirable to display either or both of threshold shells 16 and trend shells 18 as partial shells of planes in reduced regions around the respective variable cones 14, as illustrated in, for example, FIGS. 2B and 2B, rather than as complete spherical shells as illustrated in FIG. 2C. In a further alternative embodiment, only those variable cones 14 and threshold shells 16 or trend shells 18 of current significance may be displayed, such as the variable cones 14 for the most significant variables 14V of the hub 12 and the variable cones 14 and shells 16 or 18 of the variables 14V currently approaching the point of penetrating a threshold shell 16.

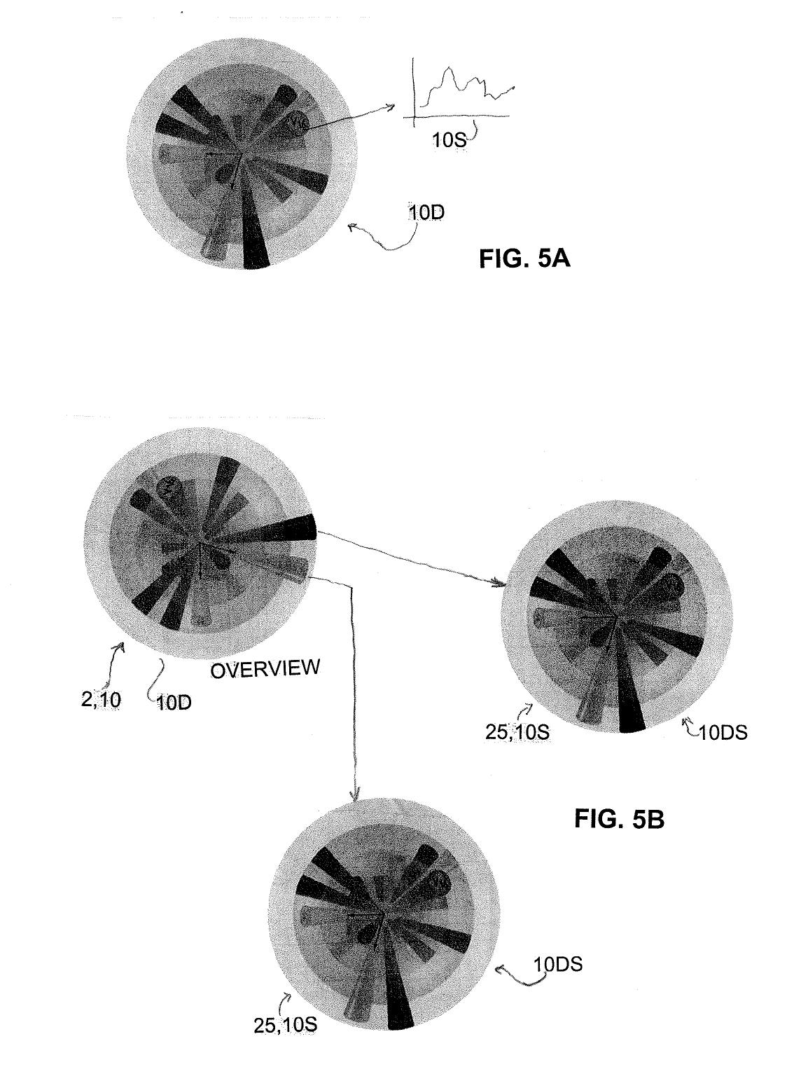

In other applications of a situational awareness system 10 of the present invention, illustrated in FIGS. 5A and 5B, a system to be monitored by a situational awareness system 10, referred to hereafter in brief as a system 2, may in turn be comprised of a plurality of processes, systems or environments, which are referred to in and for the purposes of the following discussions as sub-systems 2S, which are to be monitored by a situational awareness system 10. The sub-systems 2S of a system 2 to be monitored by a situational awareness system 10 may be comprised, for example, of a group of generally peer sub-systems 2S or a hierarchical array of sub-systems 2S or a combination thereof. For example, a peer group of sub-systems 2S may be comprised of the individual police or emergency medical units of a municipal or regional police or emergency medical system. A hierarchical array of sub-systems 2S may, for example, be found in a hospital wherein each patient is a first level sub-system 2S which is contained in one or more floors or wards which comprise second level sub-system 2S and which in turn are contained within a department sub-system 2S which comprises a third level sub-system 2S of the hierarchy.

In such instances, it will typically be desirable for the situational awareness system 10 to generate an “overview” spherical situation display 10D to provide a situation display of the variables 14V of the overall system 2, but to have the capability to quickly, easily and clearly present a display of the variables 14V of any sub-system 2S in the system 2 or at any level of hierarchy of sub-systems 2S in hierarchically structured sub-systems 2S.

First considering the case of a system 2 comprised of a group of generally peer related sub-systems 2S, each sub-system 2S in the system 2, such as a unit of a police or emergency medical unit, may be designated by a variable cone 14, each of which would be so displayed in the top level or initial spherical situation display 10D with threshold shells 16 and trend shells 18 designated and displayed as described herein above. It will be appreciated that in this instance the situational awareness system 10 will include and the spherical situation display 10D will typically include variable cones 14 pertaining to the system 2 as a whole. In addition, however, each sub-system 2S will be represented by a corresponding variable cone 14 wherein the variable 14V represented such a variable cone 14 will in fact represent one or more sub-variables 14VS that are particular to the corresponding sub-system 2S and represented or are comprised of elements of information 2I present in or entering the sub-system 2S. The types of sub-variables 14VS represented by each variable 14V may in a system having a plurality of peer related sub-systems 2 may have at least partial commonality across the system 2. For example, all of the police patrol vehicle sub-systems 2S of a police system 2 would tend to have a set of common representative sub-variables 14VS, while the variables 14V of, for example, more specialized units such as medical units would includes sub-variables 14VS specific to those units.

At least certain of the sub-variables 14VS will have associated thresholds 16T, and in the event that a sub-variable 14VS of a sub-system 2S penetrates a threshold 16T boundary of that sub-system 2S, the situational awareness system 10 would respond as described herein above and the variable cone 14 corresponding to that sub-system 2S would move to a forward position in the “overview” spherical situation display 10D, as well as assuming any other designated visual emphasis effects.

In the instance wherein the variable cone 14 corresponds to a sub-system 2S, it will often be necessary or desirable to display further details regarding the situation of the sub-system 2S in question. In certain implementations of a situational awareness system 10, as illustrated in FIG. 5A, the situational awareness system 10 may access the lower, more detailed levels of information 21 which comprise or are the source of the sub-variables 14VS of the sub-system 2S, such as raw data inputs or databases, that is, data from the original sources of the data pertaining to the sub-variables 14VS, and will display that more detailed information 2I is a separate but associated detailed display 10S.

In other implementations of a situational awareness system 10 for a system 2 including one or more peer related sub-systems 2S, as illustrated in FIG. 5B, the situational awareness system 10 may include a sub-hub 12S for and corresponding to each sub-system 2S of the system 2 and each sub-hub 2S will have associated with it the variables 14VS associated with that sub-system 2S and one or more associated sub-variable cones 14S, and at least some of the sub-variable cones 14S may include associated threshold shells 16 and trend shells 18. The situational awareness system 10 thereby includes an overview situational awareness system 10 which generates a corresponding spherical situation display 10D, as described above, and one or more situational awareness sub-systems 10S, each of which corresponds to a sub-system 2S and may contain all of the above described elements of a situational awareness system 10 and each of which can generate a corresponding spherical sub-system situation display 10DS, but wherein the variables, variable cones and threshold and trend shells of each situational awareness sub-system 10S pertains to a corresponding sub-system 2S.

In the event that a sub-variable 14VS of a sub-system 2S penetrates a threshold 16T boundary of that sub-system 2S, the situational awareness system 10 would respond as described herein above. As in case just above, the variable cone 14 corresponding to that sub-system 2S that is displayed in the spherical situation display 10D of the overview situational awareness system 10 would move to a forward position in the “overview” spherical situation display 10D, as well as assuming any other designated visual emphasis effects, including the display of variable cone designators 14D, colors changes, flashing, and so forth.

Again, the user may choose to display the lower level, more detailed information pertaining to a sub-system 2S which was the cause of a situational alert, such as a threshold penetration, or, for any other reason, may choose to display the lower level, more detailed information pertaining to any of the sub-systems 2S. In this embodiment, however, the user may elect to activate any of the situational awareness sub-systems 10S included in the situational awareness system 10, including any situational awareness sub-system 10S whose corresponding system 2 was the source of a situational alert. The situation awareness system 10 may then respond by either altering the spherical awareness display 10D to the spherical sub-system situation display 10DS generated by the situational awareness sub-system 10S corresponding to the selected sub-system 2S or by displaying a new, subsidiary situation display comprised of the spherical sub-system situation display 10DS generated by the situational awareness sub-system 10S corresponding to the selected sub-system 2S. In either instance, the user may then view the lower level, more detailed information available at the level of the selected situational awareness sub-system 10S.

Briefly considering the case of a hierarchical array of sub-systems 2S, as in the example of a hospital with patients at a first and lowest level, floors and wards at a second level and departments at a third and highest level, such systems 2 are comprised of a hierarchy of sub-systems 2S wherein the systems at a given level may be regarded, at that level, as systems 2S, and as sub-systems 2S with respect to a next higher level system 2S, and so on. In such cases, a situational awareness system 10 may be constructed as an overview situational awareness system 10 with one or more situational awareness sub-system 10S and with the situational awareness sub-system 10S at any level being an overview situational awareness system 10 for that level and potentially having at least one nest lower level situational awareness sub-system 10S, and so on downward through the successive layers of hierarchical systems 2 and 2S of the system to be monitored, with each level operating as just described for the example of a situational awareness system 10 having a single next lower level of situational awareness sub-systems 10S.

It must be noted that in further embodiments of the present invention, and according to the present invention, the number of spherical situation displays 10D at each level of the situational awareness system 10 and the relationships between the variable cones 14 in each spherical situation display 10D and the systems 2 or sub-systems 2S of the system 2 and the elements and aspects thereof will be dependent upon the particular system 2 and may, in certain implementations, be dependent upon and controlled by the complexity and rate of development or change of the system 2 and the volume, type and rate of flow on the information to be displayed by the situational awareness system 10. For example, the number of spherical situation displays 10D at each level of the situational awareness system 10 and the relationships between the variable cones 14 in each spherical situation display 10D and the systems 2 or sub-systems 2S of the system 2 and the elements and aspects thereof may become more detailed as the situation become more complex or faster changing and less detailed as the situation becomes less complex of slower to develop.

Lastly considering the case of multiple concurrent or overlapping situational alerts in a situational awareness system 10, the situational awareness system 10 may, for example, rotate each variable cone 14 corresponding to a situational alert into the forward position in the spherical situation display 10D in turn, and with any other desired visual enhancements, such as a color change or flashing, thus presenting each for consideration by the user in, for example, the sequence of occurrence of the situational alerts or according to the criticality of the situational alerts. In other implementations, the situational awareness system 10 may rotate the variable cone 14 corresponding to the first or most critical situational alert to the forward position, with the desired visual enhancements, while indicating the variable cones 14 corresponding to the other situational alerts with various combinations of visual enhancements, again such as color changes or flashing, with the visual enhancements for each variable cone 14 being selected according to the criticality of the corresponding situational alert or the sequence of occurrence of the corresponding situational alerts.

In yet other implementations of a situational awareness system 10 having multiple concurrent or overlapping situational alerts, the situational awareness system 10 may respond to each situational alert by activating and displaying a spherical situation display 10D for each variable cone 14 associated with a situational alert, with each such subsidiary spherical situation display 10D focusing on the variable cone 14 representing the variable 14V that initiated the situation alert. The display of subsidiary spherical situation displays 10D may be, for example, automatic at the occurrence of a situational alert, or at the choice and selection of the user. In a like manner, a user may, at the discretion and choice of the user and for any reason, select and activate subsidiary spherical situation displays 10D for any of the variable cones 14 displayed in the initial spherical situation display 10D.

### (5) Exemplary Embodiments of a Situational Awareness System

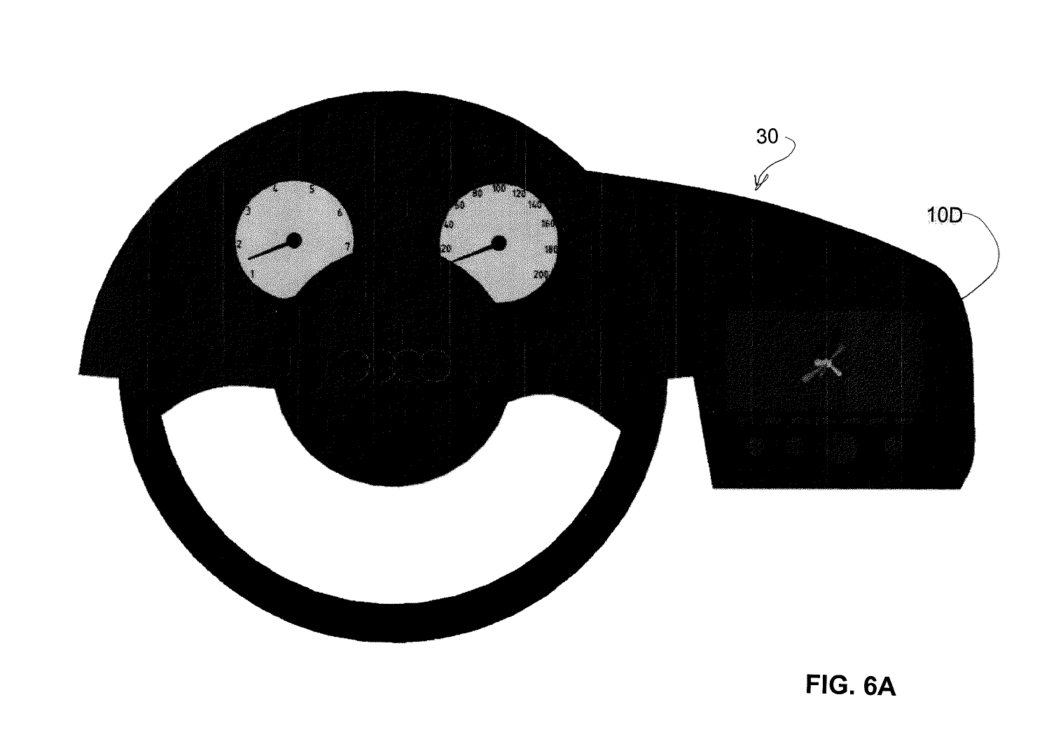

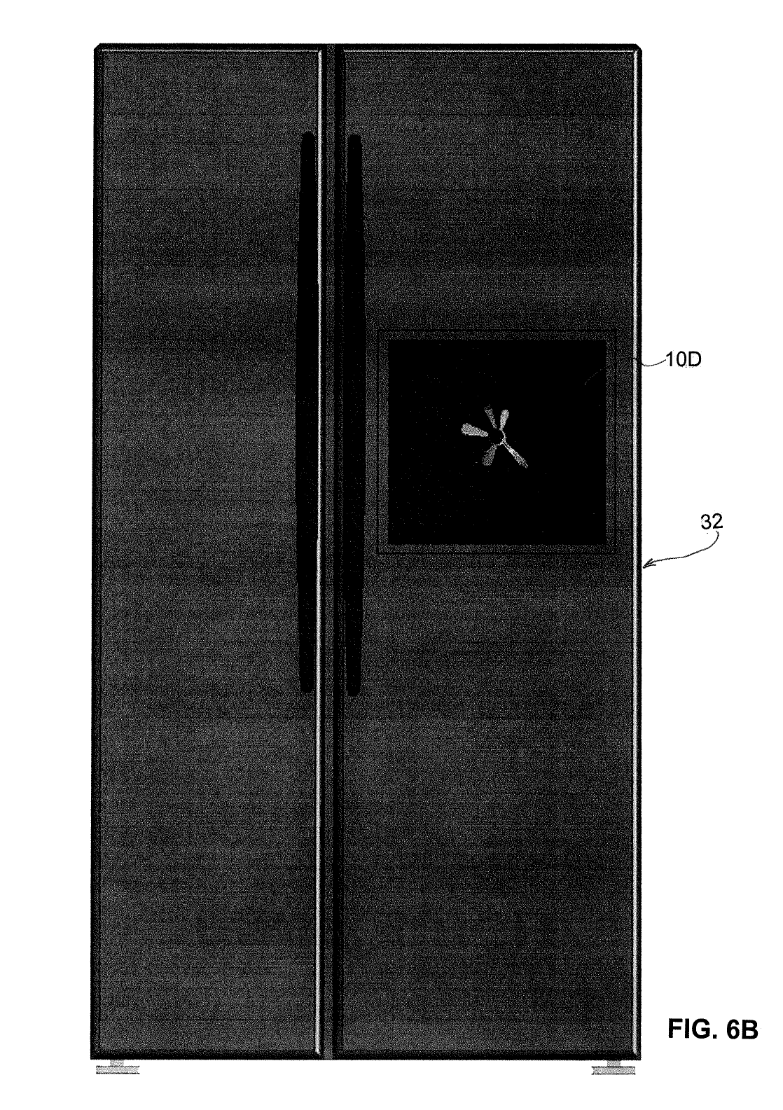

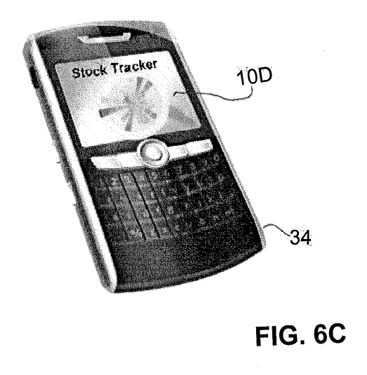

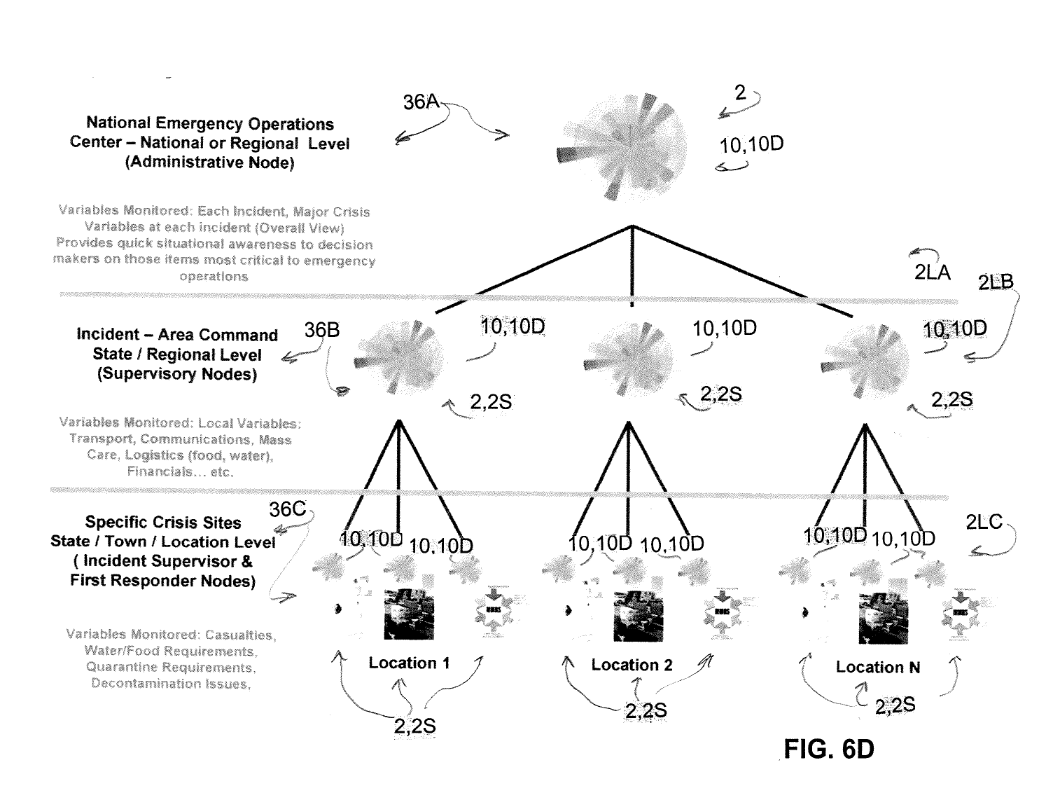

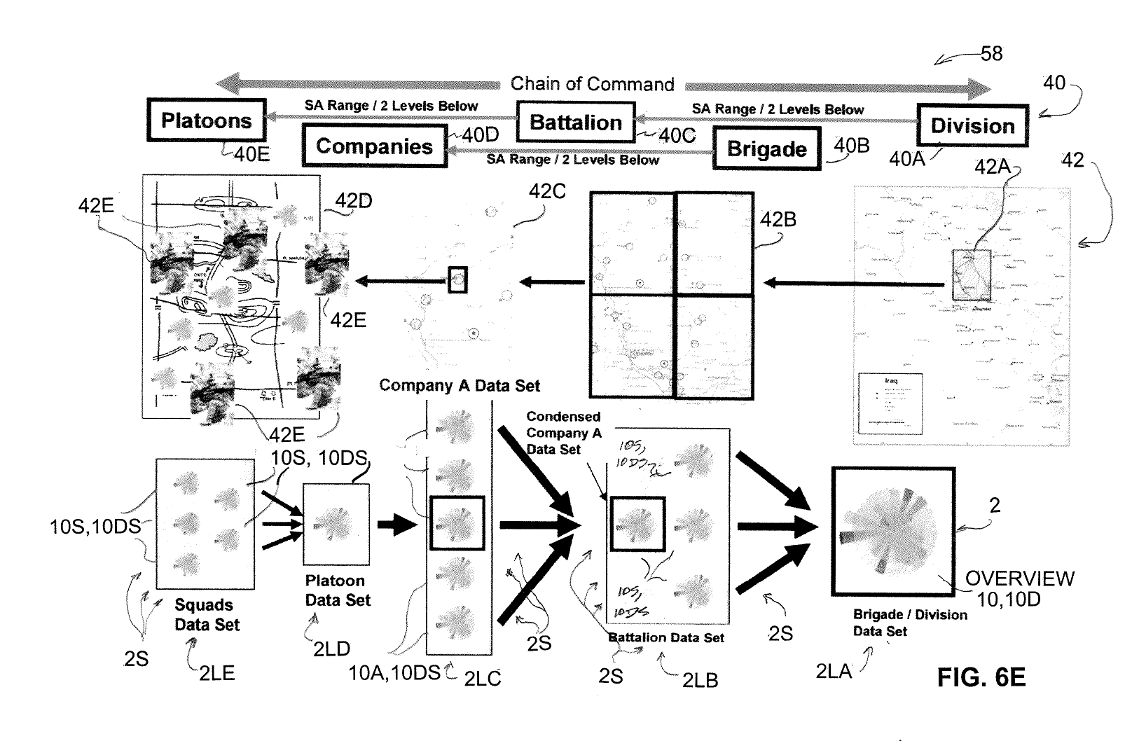

Referring now to FIGS. 6A-6F, therein are shown exemplary embodiments and applications of situational awareness systems 10 of the present invention, ranging from lower range and simpler systems 2 to highly complex systems 2.

FIG. 6A, for example, illustrates the use of a situational awareness system 2 for monitoring various aspects of the operation of a motor vehicle. Such monitored aspects of a vehicle such as an automobile, may include, for example, the state of operation of the various vehicle sub-systems, such as the engine, transmission, brakes, fuel, electrical, and passenger support systems, such as heating and air conditioning and media systems, and the driving performance and operations of the vehicle, such as speed, traction control, anti-skid, and automatic driving warning and control systems, such as collision vehicle avoidance systems. As illustrated, a spherical situation display 10D is, for example, mounted on the vehicle instrument panel 30 at a location easily viewable by the driver and displays the operating conditions and state of the monitored aspects of the vehicle systems and operation through a display of corresponding variable cones 14.

In this instance, and because the driver is required to focus primarily on operation of the vehicle rather than closely monitoring the spherical situation display 10D, the spherical situation display 10D may include only a relatively small number of threshold shells 16 and trend shells 18 and may instead rely initially upon the generation of alerts, such as audible alerts, to the driver when certain variables 14V penetrate or approach corresponding thresholds 16T. The corresponding visual indications in the spherical situation display 10D may be displayed at a relatively basic level of detail unless or until the driver indicates a desire for a more detailed display of the situation causing the alert.

FIG. 6B illustrates the application of a situational awareness system 10 for monitoring the storage of food, medical supplies or medical specimens, such as in a refrigerator or freezer in a home, restaurant, institution, medical facility, and so on, and includes a spherical situation display 10D on a prominently visible location on, for example, a cold storage unit 32. In this instance, the variables 14V monitored by the situational awareness system 10 would include, for example, interior temperature of the storage unit 32, with monitoring and display of temperature threshold shells 16 and temperature trend shells 18. Other aspects monitored by the situational awareness system 10 could, for example, include the accumulated storage time of various food products or medications stored in the storage unit 32, with tracking of storage temperature history and actual, accumulated shelf life and limits alerts when various products stored therein have exceeded or approached their safe shelf lives.

FIG. 6C, in turn, illustrates the application of a situational awareness system 10 and spherical situation display 10D in a hand held information device 34, such as a cell phone, “intelligent phone”, personal digital assistant, netbook, notebook or laptop computer, pad computer or other device of similar size and capabilities, including ebook readers. It will be appreciated that in this example, and because of the general capability of such devices to access virtually any information or systems that are accessible through the Internet or telephone systems, the situational awareness system 10 is correspondingly capable of monitoring any system 2 that is accessible through the Internet or telephone systems. The embodiment illustrated in FIG. 6C, for example, is employed for tracking stocks other financial transactions and systems, such a situational awareness system 10 may be used, for example, to track and access books, documentation, video and audio information and reports on line, track medical conditions, communicate with the monitor travel arrangements, progress of shipments, weather, news, and so on.

Referring to FIG. 6D, therein is illustrated an embodiment of a situational awareness system 10 for a significantly more complex system 2, this example being a situational awareness system 10 for monitoring operations during a national emergency situation, such as a hurricane, earthquake, flood, tornado or other environmental disaster, a nuclear, chemical or biological attack or outbreak, and other events of similar magnitude, complexity and time constraints.

As is well known, rescuers, first responders, incident managers and other personnel involved in dealing with national or wide area emergencies often must provide care to overwhelming numbers of victims and restoring basic needs including food, water, medical care, and shelter, over significant areas and typically in environments wherein normal communications and modes of transport and even basic resources, such as medical supplies and personnel, water, food and shelter are crippled, critically limited or non-existent. Such efforts require managers to be in constant communication, to have a continuous flow of data to achieve situational awareness, including information regarding the status of resources, the number, state and locations of victims, the location and capacity status of hospitals and other medical resources and facilities.

As shown therein, and as discussed above, the national emergency response system 2 monitored by a situational awareness system 10 as illustrated in FIG. 6D is comprised of a plurality of systems 2 having a multi-level hierarchical relationship, with the system 2 including a plurality of hierarchical system levels 2L. As illustrated in FIG. 6D, the system levels 2L may include, for example, system levels 2LA, 2LB, 2LC and so on, and each system level 2L may, for example, include one or more peer systems 2 or sub-systems 2S.

It will be appreciated that this model for an embodiment of a situational awareness system 10 may apply in any hierarchically structured or organized system 2, including, for example and as discussed above, a hospital wherein each patient is a first level sub-system 2S residing in one of one or more floors or wards wherein each floor or ward comprises a second, higher level of sub-system 2S, which in turn are contained each within a next higher level department sub-system 2S, each of which comprises a third level sub-system 2S of the hierarchy. It will be recognized that a system 2 on a given level may therefore be a sub-system 2S with respect to a system 2 of a higher system level 2L, and a system 2 with respect to a system 2 of a lower system level 2S.

As illustrated in FIG. 6D, system level 2LA of the situational awareness system 10 includes at least one overview situational awareness system 10 and spherical situation display 10D and, in the example shown therein, may be located at a national emergency awareness node 36A which may comprise a national or regional administrative node for monitoring and control of the systems 2 organized and structured to deal with a particular type of national emergency situation. System level 2B, in turn, may include one or more sub-nodes 36B, each of which comprises a system 2 that includes a situational awareness system 10 and spherical situation display 10D, is structured and organized to deal with situations at an incident, area, state or regional level and is a sub-system 2S with respect to the overview system 2 of system level 2A. System level 2C, in turn, may include one or more sub-nodes 36C, each of which comprises a system 2 that includes a situational awareness system 10 and spherical situation display 10D, is structured and organized to deal with situations at a state, town or local level and is a sub-system 2S with respect to at least one system 2/sub-system 2S of system level 2B.

As discussed herein above, a situational awareness system 10 of the present invention at any system level 2L may include the capability to “drill down” through the levels of information extraction from, for example, the top system level 2LA represented by an overview spherical situation display 10D to, for example, at least certain sub-systems 2S of lower system levels 2L to display the variable cones 14, variables 14V and even the information 2 from the original information sources of the sub-systems 2S of the lower system levels 2L, such as raw data inputs or databases. As such, the overview situational awareness system 10 on system level 2LA of the embodiment shown in FIG. 6D may have the capability to view detailed, raw or original input information from some of all of the sub-systems 2S on system levels 2LB and 2LC, and so on.

Again, and according to the present invention, the number of spherical situation displays 10D at each level of the situational awareness system 10 and the relationships between the variable cones 14 in each spherical situation display 10D and the systems 2 or sub-systems 2S of the system 2 and the elements and aspects thereof will be dependent upon the particular system 2 and may, in certain implementations, be dependent upon and controlled by the complexity and rate of development or change of the system 2 and the volume, type and rate of flow on the information to be displayed by the situational awareness system 10. For example, the number of spherical situation displays 10D at each level of the situational awareness system 10 and the relationships between the variable cones 14 in each spherical situation display 10D and the systems 2 or sub-systems 2S of the system 2 and the elements and aspects thereof may become more detailed as the situation become more complex or faster changing and less detailed as the situation becomes less complex of slower to develop.

Next considering FIG. 6E, therein is illustrated an embodiment of a situational awareness system 10 for a second type of complex system 2, this example being a situational awareness system 10 for monitoring and displaying operations during a military or quasi-military conflict.

As is well known, situational awareness in a conflict situation is the ability to maintain a constant, clear mental picture of the tactical situation. This picture includes an understanding of both the friendly and enemy situations and of relevant terrain and entails the ability to relate battlefield information and events through space and time to form logical conclusions and make decisions that anticipate events. The need for situational awareness extends through multiple levels of the force organization and operations, ranging from, for example, the level of the colonel or general commanding a division, brigade or battalion to the individual company, platoon, squad and section leaders. The upper level commander, such as a colonel or even a general, must have the situational awareness to structure the battlefield based on the conditions of moment, the size of opposing force, the specialized requirements the terrain requires and his own commander's overall objective. The lower levels of the force, such as the platoon, normally or often operate dispersed as individual sections or squads and, as such, it is essential that all platoon, squad and section leaders maintain situational awareness so they can make sound, quick tactical decisions.

It will be recognized that the strategy and tactics employed at any level of the military structure and operations will effect each level of structure and operations, ranging down to the squad and section level and upward to the division, brigade, battalion and company levels. For example, each level in the command is trained in a specific way and each subsequent commander down to a lieutenant commanding a platoon or to a sergeant commanding a squad, are assigned tasks tailored to match each of their units' capabilities and strengths. In terms of a scout platoon leader, for example, which are a specialized group tasked with monitoring and reporting on the status of the battlefield, the specific details of mission planning affect their ability to maintain situational awareness of the battlefield. It is also understood that the framework of the battlefield can vary from a very rigid extreme with obvious front and rear boundaries and closely tied adjacent units to a dispersed and decentralized structure with few secure areas and unit boundaries and no definable front or rear, and with corresponding effects on the operations of the force at each level.

It will also be understood that there are an unlimited number of variations of the requirements for situational awareness, depending upon the specific circumstances of any managed conflict. For example, the acquisition and maintaining of situational awareness becomes more difficult as the battlefield becomes less structured and modern, highly mobile operations with small forces lend themselves to a less rigid framework that challenges the scout's ability to maintain an accurate picture of the battlefield. For example, it is generally necessary for a scout platoon leader to have situational awareness of the entire friendly force, to at least one or more levels higher than his own, to acquire and report adequate and accurate situational awareness his portion of the battlefield to the higher levels of command.

In summary, therefore, it is obvious that the commander at any level must have a relatively complete knowledge of the terrain and his own forces disposition, capabilities, status and activities, and as much as possible about the enemy, in order to manage his force. A recurring problem in modern warfare, however, and in contrast to warfare in preceding eras, is that the quantity and rate of information flow often overwhelms the ability of a commander to perceive, absorb, evaluate and process the relevant information in a time and manner to make accurate critical decisions.

According to the present invention, a situational awareness system 10 and spherical situation display 10D provides a commander with a detailed and accurate picture of the battlefield and all available important tactical information, including friendly and enemy positions and relevant terrain, including the ability to observe and collect data form various sources, orient and assess the data to fit the current conditions, decide on a course of action or realignment of forces, act on those decisions by placing into effect a solution or response to those new conditions, and then plan the next scenario that might emerge.

As illustrated in FIG. 6E, a commander will typically plot and update locations of friendly forces and units that are operating nearby as well as enemy forces, giving each a unique color to allow for quick identification. For example, and for simplification and to reduce clutter the commander may, for example, place a dot with a number to identify these forces. A situational awareness system 10 and spherical situation display or displays 10D, in turn, allow commander to not only display all such information relevant to, for example, friendly and enemy forces, terrain features, and so on, in an easily comprehended manner, but to detect and view in detail any aspects of a situation that may warrant or require a study of more detailed information.

Referring therefore to FIG. 6E, an exemplary situational awareness system 10 for a military or quasi-military conflict is shown therein. An upper row of FIG. 6E represents the various levels of reporting and command comprising a chain of command 38 of a military force 40 comprised, in this example, of a division 40A comprised of one or more brigades 40B, each of which are in turn comprised of one or more battalions 40C. Each battalion 40C may in turn be comprised of one or more companies 40D, each of which may be comprised of one or more platoons 40E. Each platoon 40E, in turn and is well know, may be comprised of one or more squads, each of which may be comprised of one or more sections.

Below and parallel to the exemplary force 40 is shown a typical and exemplary geographical disposition 42 for a force 40 at various levels of detail corresponding in an illustrative manner to the regions and geographical scope of interest, awareness and operations of each exemplary unit or element of the force 40. For example, the division 40A is concerned with the disposition and operations of the units of the division 40A with regard to a major regional divisional area 42A, such as a country or significant portion thereof or a province or state or other significant administrative or geographical or ethnic region of a country or region. A brigade 40B or battalion 40C would be concerned with the disposition and operations of the units of the brigade 40B or battalion 40C with regard to a correspondingly smaller brigade or battalion area or region 42B with the divisional area 42A, and a company 40D with a yet correspondingly smaller company area or region 42C within the brigade or battalion area or region 42B. Lastly, platoons 40E would be concerned with correspondingly still smaller platoon areas or regions 42D within the company area or region 42C, and the squads and sections of a platoon 40E would be concerned with squad or section areas or regions 42E within the platoon area or region 42D.

It will be apparent from FIG. 6E that, as in the case of the situational awareness system 10 discussed with regard to FIG. 6D, the system 2 model for a conflict situation will typically be a multi-level, hierarchically structured or organized system. As illustrated in the lower section of FIG. 6E, an exemplary situational awareness system 10 for a military or quasi-military conflict may therefore correspondingly include an overview situational awareness system 10 and spherical situation display 10D at system level 2A of the system 2, which in this example comprises a divisional level system 2 which provides the divisional command staff with an overview of the situational state of the division 40A as unit. The divisional level 2LA overview spherical situation display 10D may, for example, be comprised of a single spherical situation display 10D with each variable cone 14 therein representing, for example, the situational state of a brigade 40B, battalion 40C or company 40D of the division 40A, or may include, for example, a spherical situation display 10D for each brigade 40B or battalion 40C with each variable cone 14 thereof representing an aspect or element of, for example, a company 40D of the division 40A, and so on.

As illustrated, system level 2LB, that is, the brigade/battalion level of the situational awareness system 10, is comprised of brigade and battalion level sub-systems 2S with corresponding sub-system level situational awareness systems 10S and spherical situation displays 10DS representing the situational state of the companies 40D of the brigades 40B and battalions 40C.

Level 2LC of the situational awareness system 10 is in turn the company 40D level of the situational awareness system 10 and comprised of company level sub-systems 2S with corresponding sub-system level situational awareness systems 10S and spherical situation displays 10DS representing the situational state of platoons 40E of the companies 40D.

Level 2LD of the situational awareness system 10, in turn, is the platoon 40E level of the situational awareness system 10 and comprised of platoon level sub-systems 2S with corresponding sub-system level situational awareness systems 10S and spherical situation displays 10DS representing the situational state of the squads of the companies 40D. As indicated generally, the situational awareness system 2 may often include at least one further lower level of functionality in squad level sub-systems 2S with corresponding sub-system level situational awareness systems 10S and spherical situation displays 10DS representing the situational state of the sections or even the individual members of the squads.

lastly, it should be noted that the local situational awareness sub-systems 10S at the brigade, battalion and divisional levels will typically be comprised of “desktop” or “laptop” level systems, or systems integrated into the divisional, brigade or battalion level command and control systems, in either fixed or mobile facilities and vehicles. At the platoon level, however, and in particular at the squad level, the local situational awareness sub-systems 10S may typically be implemented in hand-held or cell type devices to meet portability and weight/volume restrictions at these levels, although at least some systems at the platoon level may be implemented in or as vehicle mobile systems.

It will again be noted with regard to the number of spherical situation displays 10D at each level of the illustrated situational awareness system 10, and the relationships between the information displayed at each level, that, as discussed above, the number of spherical situation displays 10D at each level of the situational awareness system 10 and the relationships between the variable cones 14 in each spherical situation display 10D and the systems 2 or sub-systems 2S of the system 2 and the elements and aspects thereof will be dependent upon the particular system 2 and may, in certain implementations, be dependent upon and controlled by the complexity and rate of development or change of the system 2 and the volume, type and rate of flow on the information to be displayed by the situational awareness system 10. For example, the number of spherical situation displays 10D at each level of the situational awareness system 10 and the relationships between the variable cones 14 in each spherical situation display 10D and the systems 2 or sub-systems 2S of the system 2 and the elements and aspects thereof may become more detailed as the situation becomes more complex or faster changing and less detailed as the situation becomes less complex or slower to develop.

Since certain changes may be made in the above described improved feed mechanism for feeding a boring bar, without departing from the spirit and scope of the invention herein involved, it is intended that all of the subject matter of the above description or shown in the accompanying drawings shall be interpreted merely as examples illustrating the inventive concept herein and shall not be construed as limiting the invention.

Wherefore, I/We claim:

1. A method for generating a situational awareness display for displaying at least one state of at least one variable of a system to be monitored, comprising the steps of:
generating a spherical situation display representing the state of the at least one monitored variable of the system, including
at least one hub representing the system to be monitored,
at least one variable cone representing at least one corresponding variable of the system to be monitored,
each variable cone extending radially from a representation of the but and having a radial extent at a width representative of a characteristic of a corresponding variable of the system, and
at least one threshold shell in association with at least one variable cone,
each threshold shell representing a boundary of at least one characteristic of the corresponding variable of the system; and
modifying at least one characteristic of a variable cone of the situational awareness display to represent a corresponding change of the corresponding variable of the system.

2. The method of claim 1 for generating a situational awareness display for displaying at least one state of at least one monitored variable of the system, the spherical situation display further including:
at least one trend shell in association with at least one variable cone,
each trend shell representing a current value of a corresponding characteristic of the corresponding variable of the system.

3. The method of claim 1 for generating a situational awareness display for displaying at least one state of at least one monitored variable of the system, wherein the step of modifying at least one characteristic of a variable cone of the situational awareness display includes:
at least one of
modifying a displayed visual characteristic of the variable cone, and
generating a corresponding non-visual indication.

4. The method of claim 1 for generating a situational awareness display for displaying at least one state of at least one variable of a system to be monitored, wherein the step of modifying a displayed visual characteristic of the variable cone includes:
at least one of
visually rotating the variable cone in the spherical situation display to an orientation toward a viewer of the situational awareness display, and
modifying a second displayed visual characteristic of the variable cone, including at least one of
displaying an identifier of the corresponding variable of the system,
modifying at least one dimension of the visual display of the variable cone,
modifying a static visual characteristic of the variable cone, and
imposing a dynamic alteration of a displayed visual characteristic o the variable cone.

5. The method of claim 1 for generating a situational awareness display for displaying at least one state of at least one variable of a system to be monitored, further including the steps of:
detecting when a monitored variable associated with a variable cone penetrates a threshold boundary associated with the monitored variable, and
modifying at least one characteristic of a corresponding threshold shell, including at least one of
modifying a displayed visual characteristic of the threshold shell; and
generating a corresponding non-visual indication.

6. The method of claim 5 for generating a situational awareness display for displaying at least one state of at least one variable of a system to be monitored, wherein the step of modifying a displayed visual characteristic of the threshold shell includes:
at least one of
modifying a second displayed visual characteristic of the threshold shell, including at least one of
displaying an identifier of the corresponding variable of the system,
modifying at least one dimension of the visual display of the threshold shell,
modifying a static visual characteristic of the threshold shell, and
imposing a dynamic alteration of a displayed visual characteristic of the threshold shell.

7. The method of claim 1 for generating a situational awareness display for displaying at least one state of at least one variable of a system to be monitored, further including the steps of:
detecting when a monitored trend associated with a monitored variable of the system approaches a threshold boundary associated with the monitored variable, and
modifying at least one characteristic of the corresponding trend shell, including at least one of
modifying a displayed visual characteristic of the trend shell, and
generating a corresponding non-visual indication.

8. The method of claim 7 for generating a situational awareness display for displaying at least one state of at least one variable of a system to be monitored, wherein the step of modifying a displayed visual characteristic of the trend shell includes:
at least one of
modifying a second displayed visual characteristic of the trend shell, including at least one of
displaying an identifier of the corresponding variable of the system,
modifying at least one dimension of the visual display of the trend shell,
modifying a static visual characteristic of the trend shell, and
imposing a dynamic alteration of a displayed visual characteristic of the trend shell.

9. The method of claim 1 for generating a situational awareness display for displaying at least one state of at least one variable of a system to be monitored wherein the system to be monitored includes a plurality of sub-systems, comprising:
generating a situational awareness display comprised of a plurality of spherical situation displays, each spherical situation display representing at least one state of at least one monitored variable of a corresponding sub-system and including
at least one hub representing the sub-system to be monitored,
at least one variable cone representing at least one corresponding variable of the sub-system to be monitored,
each variable cone extending radially from a representation of the but and having a radial extent at a width representative of a characteristic of a corresponding variable of the sub-system, and
at least one threshold shell in association with at least one variable cone,
each threshold shell representing a boundary of at least one characteristic of the corresponding variable of the sub-system; and
modifying at least one characteristic of a variable cone of a situational awareness display to represent a corresponding change of a corresponding variable of the corresponding sub-system.

10. The method of claim 9 for generating a situational awareness display for displaying at least one state of at least one variable of a system to be monitored wherein the system to be monitored includes a plurality of sub-systems, wherein at least one spherical situation display further includes:
at least one trend shell in association with at least one variable cone,
each trend shell representing a current value of a corresponding characteristic of the corresponding variable of the corresponding sub-system.

11. The method of claim 9 for generating a situational awareness display for displaying at least one state of at least one variable of a system to be monitored wherein the system to be monitored includes a plurality of sub-systems, wherein the step of modifying at least one characteristic of a variable cone of the situational awareness display includes:
at least one of
modifying a displayed visual characteristic of the variable cone, and
generating a corresponding non-visual indication.

12. The method of claim 11 for generating a situational awareness display for displaying at least one state of at least one variable of a system to be monitored wherein the system to be monitored includes a plurality of sub-systems, wherein the step of modifying a displayed visual characteristic of the variable cone includes:
at least one of
visually rotating the variable cone in the spherical situation display to an orientation toward a viewer of the situational awareness display, and
modifying a second displayed visual characteristic of the variable cone, including at least one of
displaying an identifier of the corresponding variable of the corresponding sub-system,
modifying at least one dimension of the visual display of the variable cone,
modifying a static visual characteristic of the variable cone, and
imposing a dynamic alteration of a displayed visual characteristic o the variable cone.

13. The method of claim 9 for generating a situational awareness display for displaying at least one state of at least one variable of a system to be monitored wherein the system to be monitored includes a plurality of sub-systems, further including the steps of:
detecting when a monitored variable associated with a variable cone penetrates a threshold boundary associated with the monitored variable; and
modifying at least one characteristic of a corresponding threshold shell, including at least one of
modifying a displayed visual characteristic of the threshold shell, and
generating a corresponding non-visual indication.

14. The method of claim 13 for generating a situational awareness display for displaying at least one state of at least one variable of a system to be monitored wherein the system to be monitored includes a plurality of sub-systems, wherein the step of modifying a displayed visual characteristic of the threshold shell includes:
at least one of
modifying a second displayed visual characteristic of the threshold shell, including at least one of
displaying an identifier of the corresponding variable of the corresponding sub-system,
modifying at least one dimension of the visual display of the threshold shell,
modifying a static visual characteristic of the threshold shell, and
imposing a dynamic alteration of a displayed visual characteristic of the threshold shell.

15. The method of claim 9 for generating a situational awareness display for displaying at least one state of at least one variable of a system to be monitored wherein the system to be monitored includes a plurality of sub-systems, further including the steps of:
detecting when a monitored trend associated with a monitored variable of the corresponding sub-system approaches a threshold boundary associated with the monitored variable; and
modifying at least one characteristic of the corresponding trend shell, including at least one of
modifying a displayed visual characteristic of the trend shell, and
generating a corresponding non-visual indication.

16. The method of claim 15 for generating a situational awareness display for displaying at least one state of at least one variable of a system to be monitored wherein the system to be monitored includes a plurality of sub-systems, wherein the step of modifying a displayed visual characteristic of the trend shell includes:
at least one of
modifying a second displayed visual characteristic of the trend shell, including at least one of
displaying an identifier of the corresponding variable of the corresponding sub-system,
modifying at least one dimension of the visual display of the trend shell,
modifying a static visual characteristic of the trend shell, and
imposing a dynamic alteration of a displayed visual characteristic of the trend shell.

17. The method of claim 9 for generating a situational awareness display for displaying at least one state of at least one variable of a system to be monitored wherein the system to be monitored includes a plurality of sub-systems, further including the steps of:
generating a spherical situation display for the system; and
displaying the spherical situation display corresponding to the system, and
at least one of
displaying the spherical situation displays corresponding to the system and to at least selected ones of the sub-systems, and
detecting a threshold penetration by a monitored variable of a sub-system and displaying a spherical situation display corresponding to the sub-system in which the monitored variable penetrated the threshold, and
displaying the spherical situation display of a sub-system selected by a user of the situational awareness system.

18. The method of claim 1 for generating a situational awareness display for displaying at least one state of at least one variable of a system to be monitored, further including displaying information pertaining to at least one variable not represented by a variable cone, comprising the step of:
generating and displaying one of
a secondary spherical situation display for the at least one variable not represented by a variable cone of the spherical situation display, and
displaying the information pertaining to the at least one variable not represented by a variable cone by generating a display of original data extracted from a data source providing data represented by the at least one variable not represented by a variable cone of the spherical situation display.

19. A situational awareness system for displaying at least one state of at least one variable of a system to be monitored, comprising:
an information extraction processor for extracting information pertaining to the at least one monitored variable from original information sources and generating at least one corresponding variable values representing the at least one monitored variable;
a variable cone processor responsive to the at least one monitored variable for generating at least one corresponding variable cone wherein each variable cone represents at least one corresponding variable value; and
a threshold processor for comparing the variable values of the at least one monitored variable with at least one corresponding threshold boundary and generating a threshold boundary penetration indication when an at least one monitored variable penetrates an at least one corresponding threshold boundary, and
a display generator responsive to each of the at least one variable cone and to each of the at least one threshold boundary for generating a spherical situation display, the spherical situation display including
at least at least one visual representation of a hub representing the system to be monitored,
at least one variable cone representing the at least one corresponding monitored variable of the system,
each variable cone extending radially from a representation of the but and having a radial extent at a width representative of a characteristic of a corresponding variable of the system, and
at least one threshold shell in association with at least one variable cone,
each threshold shell representing a boundary of at least one characteristic of the corresponding variable of the system;
wherein the display generator being responsive to each variable cone and to each threshold shell for modifying at least one characteristic of a corresponding variable cone of the situational awareness display to represent the corresponding change of the corresponding monitored variable.

20. The situational awareness system of claim 19 for displaying at least one state of at least one variable of a system to be monitored, further comprising:
a trend processor responsive to the at least one monitored variable for generating at least one corresponding trend shell associated with a corresponding variable cone and representing changes in the at least one monitored variable; and,
the display processor being responsive to the trend processor for generating a display of each at least one trend shell.
